(19) United States
(12) Patent Application Publication
(10) Pub. No.: US 2025/0051219 A1
(43) Pub. Date: Feb. 13, 2025

(54) ION EXCHANGEABLE GLASS COMPOSITIONS HAVING IMPROVED MECHANICAL DURABILITY

(71) Applicant: CORNING INCORPORATED, CORNING, NY (US)

(72) Inventors: Qiang Fu, Painted Post, NY (US); Kayla Nicole Horton, Campbell, NY (US); Cedrick Alexander O’Shaughnessy, Painted Post, NY (US); Charisse Marye Spier, Horseheads, NY (US); Alana Marie Whittier, Painted Post, NY (US)

(21) Appl. No.: 18/797,619

(22) Filed: Aug. 8, 2024

Related U.S. Application Data
(60) Provisional application No. 63/531,935, filed on Aug. 10, 2023.

(51) Int. Cl. C03C 3/095; C03C 21/00

(52) U.S. Cl. CPC C03C 3/095; C03C 21/002

(57) ABSTRACT

A glass composition includes: greater than or equal to about 70 mol % and less than or equal to about 90 mol % SiO₂; greater than or equal to about 2 mol % and less than or equal to about 9 mol % Al₂O₃; greater than or equal to about 5 mol % and less than or equal to about 15 mol % Li₂O; greater than or equal to about 0 mol % and less than or equal to about 10 mol % Y₂O₃; greater than or equal to about 0 mol % and less than or equal to about 9 mol % Ta₂O₅; greater than or equal to about 0 mol % and less than or equal to about 10 mol % La₂O₃; and greater than or equal to about 0.05 mol % and less than or equal to about 1 mol % SnO₂. The sum of Y₂O₃, Ta₂O₅, and La₂O₃ may be greater than or equal to about 2 mol % and less than or equal to about 15 mol %.

This application claims the benefit of priority under 35 U.S.C. § 119 of U.S. Provisional Application Ser. No. 63/531,935 filed on Aug. 10, 2023, the content of which is relied upon and incorporated herein by reference in its entirety.

### FIELD

The present specification generally relates to glass compositions and, in particular, to ion exchangeable glass compositions having improved mechanical durability.

### TECHNICAL BACKGROUND

Glass articles, such as cover glasses, glass backplanes, housings, and the like, are employed in both consumer and commercial electronic devices, such as smart phones, smart watches, and tablets. The mobile nature of these portable devices makes the devices and the glass articles included therein particularly vulnerable to accidental drops on hard surfaces, such as the ground. Moreover, glass articles, such as cover glasses, may include “touch” functionality, which necessitates that the glass article be contacted by various objects including a user's fingers and/or stylus devices. The glass articles, therefore, must be sufficiently robust to endure accidental dropping and regular contact without damage, such as scratching. Additionally, when dropped, the glass article may forcefully fragment, causing damage and negatively impacting the functionality of the device.

Accordingly, a need exists for alternative glasses with improved mechanical properties.

### SUMMARY

According to a first aspect A1, a glass composition comprises: greater than or equal to about 70 mol % and less than or equal to about 90 mol % SiO₂; greater than or equal to about 2 mol % and less than or equal to about 9 mol % Al₂O₃; greater than or equal to about 5 mol % and less than or equal to about 15 mol % Li₂O; greater than or equal to about 0 mol % and less than or equal to about 10 mol % Y₂O₃; greater than or equal to about 0 mol % and less than or equal to about 9 mol % Ta₂O₅; greater than or equal to about 0 mol % and less than or equal to about 10 mol % La₂O₃; and greater than or equal to about 0.05 mol % and less than or equal to about 1 mol % SnO₂, wherein, Y₂O₃+Ta₂O₅+La₂O₃ is greater than or equal to about 2 mol % and less than or equal to about 15 mol %.

A second aspect A2 includes the glass composition of the first aspect A1, wherein Y₂O₃+Ta₂O₅+La₂O₃ is greater than or equal to about 2 mol % and less than or equal to about 12 mol %.

A third aspect A3 includes the glass composition of the first aspect A1 or the second aspect A2, wherein the glass composition comprises greater than or equal to about 3 mol % and less than or equal to about 8 mol % Al₂O₃.

A fourth aspect A4 includes the glass composition of any one of the first through third aspects A1-A3, the glass composition comprises greater than or equal to about 6 mol % and less than or equal to about 14 mol % Li₂O.

A fifth aspect A5 includes the glass composition of any one of the first through fourth aspects A1-A4, wherein the glass composition comprises greater than or equal to about 0.5 mol % and less than or equal to about 9.5 mol % Y₂O₃.

A sixth aspect A6 includes the glass composition of any one of the first through fifth aspects A1-A5, wherein the glass composition comprises greater than or equal to about 0.5 mol % and less than or equal to about 9 mol % Ta₂O₅.

A seventh aspect A7 includes the glass composition of any one of the first through sixth aspects A1-A6, wherein the glass composition comprises greater than or equal to about 0.5 mol % and less than or equal to about 9.5 mol % La₂O₃.

An eighth aspect A8 includes the glass composition of any one of the first through seventh aspects A1-A7, wherein the glass composition comprises greater than about 0 mol % and less than or equal to about 9 mol % ZrO₂.

A ninth aspect A9 includes the glass composition of any one of the first through eighth aspects A1-A8, wherein Al₂O₃+ZrO₂ is greater than or equal to about 2 mol % and less than or equal to about 12 mol %.

A tenth aspect A10 includes the glass composition of any one of the first through ninth aspects A1-A9, wherein the glass composition comprises greater than about 0 mol % and less than or equal to about 9 mol % MgO.

An eleventh aspect A11 includes the glass composition of any one of the first through tenth aspects A1-A10, wherein the glass composition comprises greater than about 0 mol % and less than or equal to about 9 mol % ZnO.

A twelfth aspect A12 includes the glass composition of any one of the first through eleventh aspects A1-A11, wherein ZrO₂+MgO+ZnO is greater than or equal to about 2 mol % and less than or equal to about 14 mol %.

A thirteenth aspect A13 includes the glass composition of any one of the first through twelfth aspects A1-A12, wherein R₂O−Al₂O₃ is greater than or equal to about 1 mol % and less than or equal to about 10 mol %, R₂O being the sum of Li₂O, Na₂O, and K₂O.

A fourteenth aspect A14 includes the glass composition of any one of the first through thirteenth aspects A1-A13, wherein the glass composition comprises greater than about 0.05 mol % and less than or equal to about 0.5 mol % SnO₂.

According to a fifteenth aspect A15, a glass article comprises: greater than or equal to about 70 mol % and less than or equal to about 90 mol % SiO₂; greater than or equal to about 2 mol % and less than or equal to about 9 mol % Al₂O₃; greater than or equal to about 5 mol % and less than or equal to about 15 mol % Li₂O; greater than or equal to about 0 mol % and less than or equal to about 10 mol % Y₂O₃; greater than or equal to about 0 mol % and less than or equal to about 9 mol % Ta₂O₅; greater than or equal to about 0 mol % and less than or equal to about 10 mol % La₂O₃; and greater than or equal to about 0.05 mol % and less than or equal to about 1 mol % SnO₂, wherein, Y₂O₃+Ta₂O₅+La₂O₃ is greater than or equal to about 2 mol % and less than or equal to about 15 mol %.

A sixteenth aspect A16 includes the glass article according to the fifteenth aspect A15, wherein Y₂O₃+Ta₂O₅+La₂O₃ is greater than or equal to about 2 mol % and less than or equal to about 12 mol %.

A seventeenth aspect A17 includes the glass article according to the fifteenth aspect A15 and the sixteenth aspect A16, wherein the glass article comprises greater than or equal to about 3 mol % and less than or equal to about 8 mol % Al₂O₃.

An eighteenth aspect A18 includes the glass article according to any one of the fifteenth through seventeenth aspects A15-A17, wherein the glass article comprises greater than or equal to about 6 mol % and less than or equal to about 14 mol % Li₂O.

A nineteenth aspect A19 includes the glass article according to any one of the fifteenth through eighteenth aspects A15-A18, wherein the glass article comprises greater than or equal to about 0.5 mol % and less than or equal to about 9.5 mol % Y₂O₃.

A twentieth aspect A20 includes the glass article according to any one of the fifteenth through nineteenth aspects A15-A19, wherein the glass article comprises greater than or equal to about 0.5 mol % and less than or equal to about 9 mol % Ta₂O₅.

A twenty-first aspect A21 includes the glass article according to any one of the fifteenth through twentieth aspects A15-A20, wherein the glass article comprises greater than or equal to about 0.5 mol % and less than or equal to about 9.5 mol % La₂O₃.

A twenty-second aspect A22 includes the glass article according to any one of the fifteenth through twenty-first aspects A15-A21, wherein the glass article comprises greater than about 0 mol % and less than or equal to about 9 mol % ZrO₂.

A twenty-third aspect A23 includes the glass article according to any one of the fifteenth through twenty-second aspects A15-A22, wherein Al₂O₃+ZrO₂ is greater than or equal to about 2 mol % and less than or equal to about 12 mol %.

A twenty-fourth aspect A24 includes the glass article according to any one of the fifteenth through twenty-third aspects A15-A23, wherein the glass article comprises greater than about 0 mol % and less than or equal to about 9 mol % MgO.

A twenty-fifth aspect A25 includes the glass article according to any one of the fifteenth through twenty-fourth aspects A15-A24, wherein the glass article comprises greater than about 0 mol % and less than or equal to about 9 mol % ZnO.

A twenty-sixth aspect A26 includes the glass article according to any one of the fifteenth through twenty-fifth aspects A15-A25, wherein ZrO₂+MgO+ZnO is greater than or equal to about 2 mol % and less than or equal to about 14 mol %.

A twenty-seventh aspect A27 includes the glass article according to any one of the fifteenth through twenty-sixth aspects A15-A26, wherein R₂O−Al₂O₃ is greater than or equal to about 1 mol % and less than or equal to about 10 mol %, R₂O being the sum of Li₂O, Na₂O, and K₂O.

A twenty-eighth aspect A28 includes the glass article according to any one of the fifteenth through twenty-seventh aspects A15-A27, wherein the glass article comprises greater than about 0.05 mol % and less than or equal to about 0.5 mol % SnO₂.

A twenty-ninth aspect A29 includes the glass article according to any one of the fifteenth through twenty-eighth aspects A15-A28, wherein the glass article comprises a Young's modulus greater than or equal to 60 GPa.

A thirtieth aspect A30 includes the glass article according to any one of the fifteenth through twenty-ninth aspects A15-A29, wherein the glass article comprises a fracture toughness greater than or equal to 0.7 MPa·m^{1/2}.

A thirty-first aspect A31 includes the glass article according to any one of the fifteenth through thirtieth aspects A15-A30, wherein the glass article is an ion exchanged glass article.

A thirty-second aspect A32 includes the glass article according to the thirty-first aspect A31, wherein the ion exchanged glass article comprises a maximum central tension greater than or equal to 75 MPa, as measured at an article thickness of 0.6 mm.

A thirty-third aspect A33 includes the glass article according to the thirty-first aspect A31 and a thirty-second aspect A32, wherein the ion exchanged glass article comprises a stored strain energy of greater than or equal to 10 J/m² and the glass article is non-frangible.

A thirty-fourth aspect A34 includes a consumer electronic device comprising: a housing having a front surface, a back surface, and side surfaces; and electrical components provided at least partially within the housing, the electrical components including at least a controller, a memory, and a display, the display being provided at or adjacent the front surface of the housing; wherein the display comprises the glass article of any one of the fifteenth through thirty-third aspects A15-A33.

According to a thirty-fifth aspect A35, a method of forming a glass article comprises: heating a glass composition, the glass composition comprising: greater than or equal to about 70 mol % and less than or equal to about 90 mol % SiO₂; greater than or equal to about 2 mol % and less than or equal to about 9 mol % Al₂O₃; greater than or equal to about 5 mol % and less than or equal to about 15 mol % Li₂O; greater than or equal to about 0 mol % and less than or equal to about 10 mol % Y₂O₃; greater than or equal to about 0 mol % and less than or equal to about 9 mol % Ta₂O₅; greater than or equal to about 0 mol % and less than or equal to about 10 mol % La₂O₃; and greater than or equal to about 0.05 mol % and less than or equal to about 1 mol % SnO₂, wherein, Y₂O₃+Ta₂O₅+La₂O₃ is greater than or equal to about 2 mol % and less than or equal to about 15 mol %; and cooling the glass composition to form the glass article.

A thirty-sixth aspect A36 includes the method according to the thirty-fifth aspect A35, further comprising strengthening the glass article in an ion exchange bath at a temperature greater than or equal to 450° C. to less than or equal to 500° C. for a time period greater than or equal to 1 hour to less than or equal to 24 hours to form an ion exchanged glass article.

A thirty-seventh aspect A37 includes the method according to the thirty-sixth aspect A36, wherein the ion exchanged glass article comprises a maximum central tension greater than or equal to 75 MPa, as measured at an article thickness of 0.6 mm.

A thirty-eighth aspect A38 includes the method according to the thirty-sixth aspect A36 or the thirty-seventh aspect A37, wherein the ion exchanged glass article has a thickness t and comprises a depth of compression greater than or equal to 0.075t.

A thirty-ninth aspect A39 includes the method according to any one of the thirty-sixth through thirty-eighth aspects A36-A38, wherein the ion exchanged glass article comprises a stored strain energy greater than or equal to 10 J/m² and the glass article is non-frangible.

A fortieth aspect A40 includes the method according to any one of the thirty-sixth through thirty-ninth aspects A36-A39, wherein the ion exchange bath comprises NaNO₃.

A forty-first aspect A41 includes the method according to any one of the thirty-sixth through fortieth aspects A36-A40, wherein the ion exchange bath comprises KNO₃.

### BRIEF DESCRIPTION OF THE DRAWINGS

FIG. 1 is a representation of a non-frangible sample after a frangibility test;

FIG. 2 is a representation of a frangible sample after a frangibility test;

FIG. 3 is a plan view of an electronic device incorporating any of the glass articles according to one or more embodiments described herein; and

FIG. 4 is a perspective view of the electronic device of FIG. 3.

### DETAILED DESCRIPTION

Reference will now be made in detail to various embodiments of ion exchangeable glass compositions and glass articles formed therefrom having improved mechanical durability.

According to embodiments, a glass composition may comprise greater than or equal to about 70 mol % and less than or equal to about 90 mol % SiO₂; greater than or equal to about 2 mol % and less than or equal to about 9 mol % Al₂O₃; greater than or equal to about 5 mol % and less than or equal to about 15 mol % Li₂O greater than or equal to about 0 mol % and less than or equal to about 10 mol % Y₂O₃; greater than or equal to about 0 mol % and less than or equal to about 9 mol % Ta₂O₅; greater than or equal to about 0 mol % and less than or equal to about 10 mol % La₂O₃; and; greater than or equal to about 0.05 mol % and less than or equal to about 1 mol % SnO₂. The sum of Y₂O₃, Ta₂O₅, and La₂O₃ (i.e., Y₂O₃+Ta₂O₅+La₂O₃) in the glass composition and the resultant glass article may be from greater than or equal to about 2 mol % and less than or equal to about 15 mol %. Various embodiments of ion exchangeable glass compositions and glass articles formed therefrom will be described herein with specific reference to the appended drawings.

Ranges may be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

Directional terms as used herein—for example up, down, right, left, front, back, top, bottom—are made only with reference to the figures as drawn and are not intended to imply absolute orientation.

Unless otherwise expressly stated, it is in no way intended that any method set forth herein be construed as requiring that its steps be performed in a specific order, nor that with any apparatus specific orientations be required. Accordingly, where a method claim does not actually recite an order to be followed by its steps, or that any apparatus claim does not actually recite an order or orientation to individual components, or it is not otherwise specifically stated in the claims or description that the steps are to be limited to a specific order, or that a specific order or orientation to components of an apparatus is not recited, it is in no way intended that an order or orientation be inferred, in any respect. This holds for any possible non-express basis for interpretation, including: matters of logic with respect to arrangement of steps, operational flow, order of components, or orientation of components; plain meaning derived from grammatical organization or punctuation, and; the number or type of embodiments described in the specification.

As used herein, the singular forms “a,” “an” and “the” include plural referents unless the context clearly dictates otherwise. Thus, for example, reference to “a” component includes aspects having two or more such components, unless the context clearly indicates otherwise.

In the embodiments of the glass composition and resultant glass article described herein, the concentrations of constituent components (e.g., SiO₂, Al₂O₃, and the like) are specified in mole percent (mol %) on an oxide basis, unless otherwise specified.

The term “substantially free,” when used to describe the concentration and/or absence of a particular constituent component in a glass composition and the resultant glass article, means that the constituent component is not intentionally added to the glass composition and the resultant glass article. However, the glass composition and the resultant glass article may contain traces of the constituent component as a contaminant or tramp in amounts of less than 0.05 weight percent (wt %). As noted herein, the remainder of the application specifies the concentrations of constituent component in mol %. The contaminant or tramp amounts of the constituent components are listed in wt % for manufacturing purposes and one skilled in the art would understand the contaminant and tramp amounts being listed in wt %.

The terms “0 mol %” and “free,” when used to describe the concentration and/or absence of a particular constituent component in a glass composition and the resultant glass article, means that the constituent component is not present in glass composition and the resultant glass article.

Fracture toughness (K_{1c}) represents the ability of a glass composition to resist fracture. Fracture toughness is measured on a non-strengthened glass article, such as measuring the K_{1c} value prior to ion exchange treatment of the glass article, thereby representing a feature of a glass article prior to ion exchange. The fracture toughness test methods described herein are not suitable for glasses that have been exposed to ion exchange treatment. But, fracture toughness measurements performed as described herein on the same glass article prior to ion exchange treatment correlate to fracture toughness after ion exchange treatment, and are accordingly used as such. The chevron notched short bar (CNSB) method utilized to measure the K_{1c} value is disclosed in Reddy, K. P. R. et al, “Fracture Toughness Measurement of Glass and Ceramic Materials Using Chevron-Notched Specimens,” J. Am. Ceram. Soc., 71 [6], C-310-C-313 (1988) except that Y*ₘ is calculated using equation 5 of Bubsey, R. T. et al., “Closed-Form Expressions for Crack-Mouth Displacement and Stress Intensity Factors for Chevron-Notched Short Bar and Short Rod Specimens Based on Experimental Compliance Measurements,” NASA Technical Memorandum 83796, pp. 1-30 (October 1992). Unless otherwise specified, all fracture toughness values were measured by chevron notched short bar (CNSB) method.

Density, as described herein, is measured by the buoyancy method of ASTM C693-93.

The term “strain point,” as used herein, refers to the temperature at which the viscosity of the glass composition is 1×10^{14.68} poise as measured in accordance with ASTM C598.

The term “melting point,” as used herein, refers to the temperature at which the viscosity of the glass composition is 200 poise as measured in accordance with ASTM C338.

The terms “annealing point” or “effective annealing temperature,” as used herein, refer to the temperature at which the viscosity of the glass composition is 1×10^{13.18} poise as measured in accordance with ASTM C598.

The elastic modulus (also referred to as Young's modulus) of the glass composition, as described herein, is provided in units of gigapascals (GPa) and is measured in accordance with ASTM C623.

The shear modulus of the glass composition, as described herein, is provided in units of gigapascals (GPa). The shear modulus of the glass composition is measured in accordance with ASTM C623.

Poisson's ratio, as described herein, is measured in accordance with ASTM C623.

Refractive index, as described herein, is measured in accordance with ASTM E1967.

The term “linear coefficient of thermal expansion” and “CTE,” as described herein, is measured in accordance with ASTM E228-85 over the temperature range of 25° C. to 300° C. and is expressed in terms of “×10⁻⁷/° C.” as an average over the temperature range.

Surface compressive stress is measured with a surface stress meter (FSM) such as commercially available instruments such as the FSM-6000, manufactured by Orihara Industrial Co., Ltd. (Japan). Surface stress measurements rely upon the measurement of the stress optical coefficient (SOC), which is related to the birefringence of the glass article. SOC, in turn, is measured according to Procedure C (Glass Disc Method) described in ASTM standard C770-16, entitled “Standard Test Method for Measurement of Glass Stress-Optical Coefficient,” the contents of which are incorporated herein by reference in their entirety. The values reported for surface compressive stress (CS) herein refer to the peak surface compressive stress, unless otherwise indicated. The maximum central tension (CT) values are measured using a SCALP technique known in the art. The values reported for central tension (CT) herein refer to the maximum central tension, unless otherwise indicated.

According to the convention normally used in the art, compression or compressive stress (CS) is expressed as a negative (i.e., <0) stress and tension or tensile stress is expressed as a positive (i.e., >0) stress. Throughout this description, however, CS is expressed as a positive or absolute value (i.e., as recited herein, CS=|CS|).

As used herein, “depth of compression” (DOC) refers to the depth at which the stress within the multi-phase glass changes from compressive to tensile. At the DOC, the stress crosses from a compressive stress to a tensile stress and thus exhibits a stress value of zero. Depth of compression may be measured using a Scattered Light Polariscope (SCALP), such as a SCALP-05 portable scattered light polariscope.

The stored strain energy Σ₀, as described herein, may be calculated according to the following equation:

$${Σ}_{0} = \frac{1 - v}{2 E} {\int }_{- {z}^{*}}^{+ {z}^{*}} ( {σ}_{x}^{2} + {σ}_{y}^{2} ) dz = \frac{1 - v}{2 E} {\int }_{- {z}^{*}}^{+ {z}^{*}} ( 2 {σ}^{2} ) dz$$

wherein z*=0.5t−δ, t is the thickness of the glass article, δ is the depth of compression, ν is Poisson's ratio, E is Young's modulus (in MPa), and a is central tension (in MPa). The integration is computed across the thickness (in micrometers) of the tensile region only.

As used herein, the “frangibility limit” refers to the central tension or stored strain energy above which the multi-phase glass exhibits frangible behavior. “Frangibility” or “frangible behavior” refers to specific fracture behavior when a material is subjected to an impact or insult.

As utilized herein, a multi-phase glass is considered non-frangible when it exhibits at least one of the following in a test area as a result of a frangibility test: (1) four or less fragments with a largest dimension of at least 1 mm, and/or (2) the number of bifurcations is less than or equal to the number of crack branches. The fragments, bifurcations, and crack branches are counted based on any 2 inch by 2 inch square centered on the impact point. Thus, a multi-phase glass is considered non-frangible if it meets one or both of tests (1) and (2) for any 2 inch by 2 inch square centered on the impact point where the breakage is created according to the procedure described below. In a frangibility test, an impact probe is brought in to contact with the multi-phase glass, with the depth to which the impact probe extends into the multi-phase glass increasing in successive contact iterations. The step-wise increase in depth of the impact probe allows the flaw produced by the impact probe to reach the tension region while preventing the application of excessive external force that would prevent the accurate determination of the frangible behavior of the multi-phase glass. In embodiments, the depth of the impact probe in the multi-phase glass may increase by about 5 μm in each iteration, with the impact probe being removed from contact with the multi-phase glass between each iteration. The test area is any 2 inch by 2 inch square centered at the impact point.

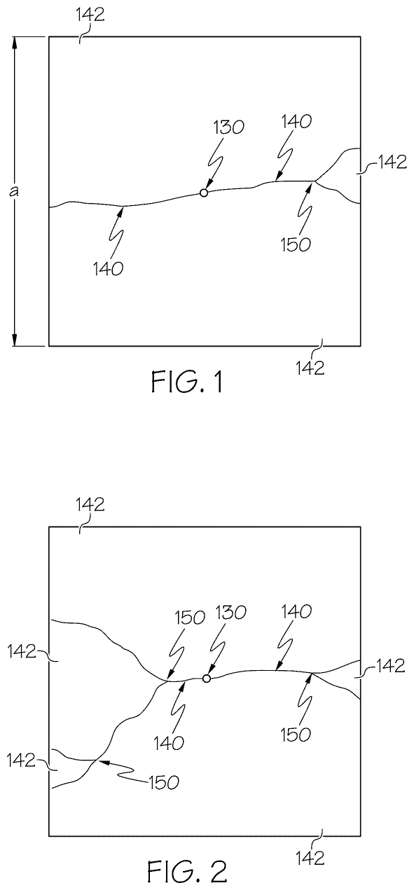

FIG. 1 depicts a non-frangible test result. As shown in FIG. 1, the test area is a square that is centered at the impact point 130, where the length of a side of the square a is 2 inches. The non-frangible sample shown in FIG. 1 includes three fragments 142, two crack branches 140, and a single bifurcation 150. Thus, the non-frangible sample shown in FIG. 1 contains less than four fragments having a largest dimension of at least 1 mm and the number of bifurcations is less than or equal to the number of crack branches. As utilized herein, a crack branch originates at the impact point, and a fragment is considered to be within the test area is any part of the fragment extends into the test area. While coatings, adhesive layers, and the like may be used in conjunction with the multi-phase glass described herein, such external restraints are not used in determining the frangibility or frangible behavior of the multi-phase glass. In embodiments, a film that does not affect the fracture behavior of the multi-phase glass may be applied to the multi-phase glass prior to the frangibility test to prevent the ejection of fragments from the multi-phase glass, increasing safety for the person performing the test.

A frangible sample is depicted in FIG. 2. The frangible sample includes five fragments 142 having crack branches 140 and three bifurcations 150, producing more bifurcations than crack branches. Thus, the sample depicted in FIG. 2 does not exhibit either four or less fragments or the number of bifurcations being less than or equal to the number of crack branches.

In the frangibility test described herein, the impact is delivered to the surface of the multi-phase glass with a force that is just sufficient to release the internally stored energy present within the strengthened multi-phase glass. That is, the point impact force is sufficient to create at least one new crack at the surface of the strengthened glass sheet and extend the crack through the compressive stress layer into the region that is under central tension (CT).

The term “liquidus temperature,” as used herein, refers to the temperature at which the glass composition begins to devitrify as determined with the gradient furnace method according to ASTM C829-81.

Chemical strengthening processes have been used to achieve high strength and high toughness in alkali silicate glasses. The frangibility of a chemically strengthened glass is generally controlled by the fracture toughness of the components of the glass and the Young's modulus of the glass. Glass articles having both relatively high K_{Ic} fracture toughness and relatively high Young's modulus may have the ability to store a high strain energy while being non-frangible. Silica has a relatively low K_{Ic} fracture toughness of approximately 0.7 MPa·m^{1/2}, which constrains the K_{Ic} fracture toughness of silicate glasses to be limited to values of about 0.7 MPa·m^{1/2}. The addition of Al₂O₃ may increase the fracture toughness of the glass composition, but may cause the liquidus viscosity to decrease, making the glass composition difficult to form.

Disclosed herein are glass compositions and resultant glass articles that mitigate the aforementioned problems. Specifically, the glass compositions and the resultant glass articles disclosed herein comprise a relatively high concentration of Y₂O₃, Ta₂O₅, and La₂O₃ (e.g., Y₂O₃+Ta₂O₅+La₂O₃ is greater than or equal to about 2 mol %), which results in ion exchangeable glass compositions having improved fracture toughness and Young's modulus to achieve a non-frangible resultant glass article.

The glass compositions and resultant glass articles described herein may be described as aluminosilicate glass compositions and articles and comprise SiO₂ and Al₂O₃. The glass compositions and resultant glass articles described herein also include Y₂O₃, Ta₂O₅, and/or La₂O₃ to increase fracture toughness and Young's modulus. The glass compositions and resultant glass articles described herein also include alkali oxides, such as Li₂O, to enable the ion exchangeability of the glass compositions.

SiO₂ is the primary glass former in the glass compositions described herein and may function to stabilize the network structure of the resultant glass articles. The concentration of SiO₂ in the glass composition and resultant glass article should be sufficiently high (e.g., greater than or equal to about 70 mol %) to provide basic glass forming capability. The amount of SiO₂ may be limited (e.g., to less than or equal to about 90 mol %) to control the melting point of the glass composition and, thus, may aid in improving the meltability and the formability of the resulting glass article.

Accordingly, in embodiments, the glass composition and resultant glass article may comprise greater than or equal to about 70 mol % and less than or equal to about 90 mol % SiO₂. In embodiments, the concentration of SiO₂ in the glass composition and the resultant glass article may be greater than or equal to about 70 mol %, greater than or equal to about 75 mol %, or even greater than or equal to about 80 mol %. In embodiments, the concentration of SiO₂ in the glass composition and the resultant glass article may be less than or equal to about 90 mol %, less than or equal to about 85 mol %, or even less than or equal to about 80 mol %. In embodiments, the concentration of SiO₂ in the glass composition and the resultant glass article may be greater than or equal to about 70 mol % and less than or equal to about 90 mol %, greater than or equal to about 70 mol % and less than or equal to about 85 mol %, greater than or equal to about 70 mol % and less than or equal to about 80 mol %, greater than or equal to about 75 mol % and less than or equal to about 90 mol %, greater than or equal to about 75 mol % and less than or equal to about 85 mol %, greater than or equal to about 75 mol % and less than or equal to about 80 mol %, greater than or equal to about 80 mol % and less than or equal to about 90 mol %, or even greater than or equal to about 80 mol % and less than or equal to about 85 mol %, or any and all sub-ranges formed from any of these endpoints.

Like SiO₂, Al₂O₃ may also stabilize the glass network and additionally provide improved mechanical properties, such as fracture toughness, and chemical durability to the resulting glass article. The amount of Al₂O₃ may also be tailored to the control the viscosity of the glass composition. The concentration of Al₂O₃ should be sufficiently high (e.g., greater than or equal to 2 mol %) such that the glass composition and the resultant glass article have the desired fracture toughness (e.g., greater than or equal to 0.7 MPa·m^{1/2}). If the amount of Al₂O₃ is too high (e.g., greater than 9 mol %), the viscosity of the melt may increase, thereby diminishing the formability of the glass composition. In embodiments, the glass composition and resultant glass article may comprise greater than or equal to about 2 mol % and less than or equal to about 9 mol % Al₂O₃. In embodiments, the glass composition and resultant glass article may comprise greater than or equal to about 3 mol % and less than or equal to about 8 mol % Al₂O₃. In embodiments, the concentration of Al₂O₃ in the glass composition and resultant glass article may be greater than or equal to about 2 mol %, greater than or equal to about 3 mol %, or even greater than or equal to about 4 mol %. In embodiments, the concentration of Al₂O₃ in the glass composition and the resultant glass article may be less than or equal about 9 mol %, less than or equal to about 8 mol %, less than or equal to about 7 mol %, or even less than or equal to about 6 mol %. In embodiments, the concentration of Al₂O₃ in the glass composition and the resultant glass article may be greater than or equal about 2 mol % and less than or equal to about 9 mol %, greater than or equal about 2 mol % and less than or equal to about 8 mol %, greater than or equal about 2 mol % and less than or equal to about 7 mol %, greater than or equal about 2 mol % and less than or equal to about 6 mol %, greater than or equal about 3 mol % and less than or equal to about 9 mol %, greater than or equal about 3 mol % and less than or equal to about 8 mol %, greater than or equal about 3 mol % and less than or equal to about 7 mol %, greater than or equal about 3 mol % and less than or equal to about 6 mol %, greater than or equal about 4 mol % and less than or equal to about 9 mol %, greater than or equal about 4 mol % and less than or equal to about 8 mol %, greater than or equal about 4 mol % and less than or equal to about 7 mol %, or even greater than or equal about 4 mol % and less than or equal to about 6 mol %, or any and all sub-ranges formed from any of these endpoints.

The glass compositions may contain alkali oxides, such as Li₂O, to enable the ion exchangeability of the glass composition. Li₂O also reduces the softening point of the glass composition, thereby increasing the formability of the glass. In embodiments, the glass composition and the resultant glass article may comprise greater than or equal to about 5 mol % and less than or equal to about 15 mol % Li₂O. In embodiments, the glass composition and the resultant glass article may comprise greater than or equal to about 6 mol % and less than or equal to about 14 mol % Li₂O. In embodiments, the concentration of Li₂O in the glass composition and the resultant glass article may be greater than or equal to about 5 mol %, greater than or equal to about 6 mol %, greater than or equal to about 7 mol %, greater than or equal to about 8 mol %, or even greater than or equal to about 9 mol %. In embodiments, the concentration of Li₂O in the glass composition and the resultant glass article may be less than or equal to about 15 mol %, less than or equal to about 14 mol %, less than or equal to about 13 mol %, less than or equal to about 12 mol %, or even less than or equal to about 11 mol %. In embodiments, the concentration of Li₂O in the glass composition and the resultant glass article may be greater than or equal to about 5 mol % and less than or equal to about 15 mol %, greater than or equal to about 5 mol % and less than or equal to about 14 mol %, greater than or equal to about 5 mol % and less than or equal to about 13 mol %, greater than or equal to about 5 mol % and less than or equal to about 12 mol %, greater than or equal to about 5 mol % and less than or equal to about 11 mol %, greater than or equal to about 6 mol % and less than or equal to about 15 mol %, greater than or equal to about 6 mol % and less than or equal to about 14 mol %, greater than or equal to about 6 mol % and less than or equal to about 13 mol %, greater than or equal to about 6 mol % and less than or equal to about 12 mol %, greater than or equal to about 6 mol % and less than or equal to about 11 mol %, greater than or equal to about 7 mol % and less than or equal to about 15 mol %, greater than or equal to about 7 mol % and less than or equal to about 14 mol %, greater than or equal to about 7 mol % and less than or equal to about 13 mol %, greater than or equal to about 7 mol % and less than or equal to about 12 mol %, greater than or equal to about 7 mol % and less than or equal to about 11 mol %, greater than or equal to about 8 mol % and less than or equal to about 15 mol %, greater than or equal to about 8 mol % and less than or equal to about 14 mol %, greater than or equal to about 8 mol % and less than or equal to about 13 mol %, greater than or equal to about 8 mol % and less than or equal to about 12 mol %, greater than or equal to about 8 mol % and less than or equal to about 11 mol %, greater than or equal to about 9 mol % and less than or equal to about 15 mol %, greater than or equal to about 9 mol % and less than or equal to about 14 mol %, greater than or equal to about 9 mol % and less than or equal to about 13 mol %, greater than or equal to about 9 mol % and less than or equal to about 12 mol %, or even greater than or equal to about 9 mol % and less than or equal to about 11 mol %, or any and all sub-ranges formed from any of these endpoints.

The glass compositions and the resultant glass articles described herein may further comprise alkali metal oxides other than Li₂O, such as Na₂O and K₂O.

In addition to aiding in ion exchangeability of the glass composition, Na₂O decreases the melting point and improves formability of the glass composition. However, if too much Na₂O is added to the glass composition, the melting point may be too low. In embodiments, the concentration of Na₂O in the glass composition and the resultant glass article may be greater than or equal to about 0 mol %, greater than or equal to about 0.5 mol %, or even greater than or equal to about 1 mol %. In embodiments, the concentration of Na₂O in the glass composition and the resultant glass article may be less than or equal to about 5 mol %, less than or equal to about 4 mol %, less than or equal to about 3 mol %, or even less than or equal to about 2 mol %. In embodiments, the concentration of Na₂O in the glass composition and the resultant glass article may be greater than or equal to about 0 mol % and less than or equal to about 5 mol %, greater than or equal to about 0 mol % and less than or equal to about 4 mol %, greater than or equal to about 0 mol % and less than or equal to about 3 mol %, greater than or equal to about 0 mol % and less than or equal to about 2 mol %, greater than or equal to about 0.5 mol % and less than or equal to about 5 mol %, greater than or equal to about 0.5 mol % and less than or equal to about 4 mol %, greater than or equal to about 0.5 mol % and less than or equal to about 3 mol %, greater than or equal to about 0.5 mol % and less than or equal to about 2 mol %, greater than or equal to about 1 mol % and less than or equal to about 5 mol %, greater than or equal to about 1 mol % and less than or equal to about 4 mol %, greater than or equal to about 1 mol % and less than or equal to about 3 mol %, or even greater than or equal to about 1 mol % and less than or equal to about 2 mol %, or any and all sub-ranges formed from any of these endpoints. In embodiments, the glass composition and the resultant glass article may be free or substantially free of Na₂O.

K₂O promotes ion exchange to increase the depth of compression and decreases the melting point to improve formability of the glass composition. However, adding K₂O may cause the surface compressive stress and melting point to be too low. In embodiments, the concentration of K₂O in the glass composition and the resultant glass article may be greater than or equal to about 0 mol % or even greater than or equal to about 0.5 mol %. In embodiments, the concentration of K₂O in the glass composition and the resultant glass article may be less than or equal to about 2 mol % or even less than or equal to about 1 mol %. In embodiments, the concentration of K₂O in the glass composition and the resultant glass article may be greater than or equal to about 0 mol % and less than or equal to about 2 mol %, greater than or equal to about 0 mol % and less than or equal to about 1 mol %, greater than or equal to about 0.5 mol % and less than or equal to about 2 mol %, or even greater than or equal to about 0.5 mol % and less than or equal to about 1 mol %, or any and all sub-ranges formed from any of these endpoints. In embodiments, the glass composition and the resultant glass article may be free or substantially free of K₂O.

In embodiments, the sum of Na₂O and K₂O (i.e., Na₂O+K₂O) may be limited (e.g., less than or equal to about 5 mol %) to ensure a sufficient ion exchange performance with respect to exchange of Li⁺ in the glass article with Na⁺ in the molten salt bath. In embodiments, Na₂O+K₂O in the glass composition and the resultant glass article may be greater than or equal to about 0 mol %, greater than or equal to about 0.5 mol % or even greater than or equal to about 1 mol %. In embodiments, Na₂O+K₂O in the glass composition and the resultant glass article may be less than or equal to about 5 mol %, less than or equal to about 4 mol %, less than or equal to about 3 mol %, or even less than or equal to about 2 mol %. In embodiments, Na₂O+K₂O in the glass composition and the resultant glass article may be greater than or equal to about 0 mol % and less than or equal to about 5 mol %, greater than or equal to about 0 mol % and less than or equal to about 4 mol %, greater than or equal to about 0 mol % and less than or equal to about 3 mol %, greater than or equal to about 0 mol % and less than or equal to about 2 mol %, greater than or equal to about 0.5 mol % and less than or equal to about 5 mol %, greater than or equal to about 0.5 mol % and less than or equal to about 4 mol %, greater than or equal to about 0.5 mol % and less than or equal to about 3 mol %, greater than or equal to about 0.5 mol % and less than or equal to about 2 mol %, greater than or equal to about 1 mol % and less than or equal to about 5 mol %, greater than or equal to about 1 mol % and less than or equal to about 4 mol %, greater than or equal to about 1 mol % and less than or equal to about 3 mol %, or even greater than or equal to about 1 mol % and less than or equal to about 2 mol %, or any and all sub-ranges formed from any of these endpoints.

R₂O is the sum (in mol %) of Li₂O, Na₂O, and K₂O present in the glass composition and the resultant glass article (i.e., R₂O=Li₂O+Na₂O+K₂O). In embodiments, the concentration of R₂O in the glass composition and the resultant glass article may be greater than or equal to about 5 mol %, greater than or equal to about 6 mol %, greater than or equal to about 7 mol %, greater than or equal to about 8 mol %, or even greater than or equal to about 9 mol %. In embodiments, the concentration of R₂O in the glass composition and the resultant glass article may be less than or equal to about 15 mol %, less than or equal to about 14 mol %, less than or equal to about 13 mol %, less than or equal to about 12 mol %, or even less than or equal to about 11 mol %. In embodiments, the concentration of R₂O in the glass composition and the resultant glass article may be greater than or equal to about 5 mol % and less than or equal to about 15 mol %, greater than or equal to about 5 mol % and less than or equal to about 14 mol %, greater than or equal to about 5 mol % and less than or equal to about 13 mol %, greater than or equal to about 5 mol % and less than or equal to about 12 mol %, greater than or equal to about 5 mol % and less than or equal to about 11 mol %, greater than or equal to about 6 mol % and less than or equal to about 15 mol %, greater than or equal to about 6 mol % and less than or equal to about 14 mol %, greater than or equal to about 6 mol % and less than or equal to about 13 mol %, greater than or equal to about 6 mol % and less than or equal to about 12 mol %, greater than or equal to about 6 mol % and less than or equal to about 11 mol %, greater than or equal to about 7 mol % and less than or equal to about 15 mol %, greater than or equal to about 7 mol % and less than or equal to about 14 mol %, greater than or equal to about 7 mol % and less than or equal to about 13 mol %, greater than or equal to about 7 mol % and less than or equal to about 12 mol %, greater than or equal to about 7 mol % and less than or equal to about 11 mol %, greater than or equal to about 8 mol % and less than or equal to about 15 mol %, greater than or equal to about 8 mol % and less than or equal to about 14 mol %, greater than or equal to about 8 mol % and less than or equal to about 13 mol %, greater than or equal to about 8 mol % and less than or equal to about 12 mol %, greater than or equal to about 8 mol % and less than or equal to about 11 mol %, greater than or equal to about 9 mol % and less than or equal to about 15 mol %, greater than or equal to about 9 mol % and less than or equal to about 14 mol %, greater than or equal to about 9 mol % and less than or equal to about 13 mol %, greater than or equal to about 9 mol % and less than or equal to about 12 mol %, or even greater than or equal to about 9 mol % and less than or equal to about 11 mol %, or any and all sub-ranges formed from any of these endpoints.

In embodiments, the difference between R₂O and Al₂O₃ in the glass composition and the resultant glass article (i.e., R₂O−Al₂O₃) may be greater than or equal to about 1 mol % and less than or equal to about 10 mol %. In embodiments, R₂O−Al₂O₃ in the glass composition and the resultant glass article may be greater than or equal to about 1 mol %, greater than or equal to about 2 mol %, or even greater than or equal to about 3 mol %. In embodiments, R₂O−Al₂O₃ in the glass composition and the resultant glass article may be less than or equal to about 10 mol %, less than or equal to about 7 mol %, or even less than or equal to about 5 mol %. In embodiments, R₂O−Al₂O₃ in the glass composition and the resultant glass article may be greater than or equal to about 1 mol % and less than or equal to about 10 mol %, greater than or equal to about 1 mol % and less than or equal to about 7 mol %, greater than or equal to about 1 mol % and less than or equal to about 5 mol %, greater than or equal to about 2 mol % and less than or equal to about 10 mol %, greater than or equal to about 2 mol % and less than or equal to about 7 mol %, greater than or equal to about 2 mol % and less than or equal to about 5 mol %, greater than or equal to about 3 mol % and less than or equal to about 10 mol %, greater than or equal to about 3 mol % and less than or equal to about 7 mol %, or even greater than or equal to about 3 mol % and less than or equal to about 5 mol %, or any and all sub-ranges formed from any of these endpoints.

As noted hereinabove, Y₂O₃ may increase the fracture toughness and Young's modulus of the glass composition and the resultant glass article described herein. In embodiments, the glass composition and the resultant glass article may comprise greater than or equal to about 0 mol % and less than or equal to about 10 mol % Y₂O₃. In embodiments, the glass composition and the resultant glass article may comprise greater than or equal to about 0.5 mol % and less than or equal to about 9.5 mol % Y₂O₃. In embodiments, the concentration of Y₂O₃ in the glass composition and the resultant glass article may be greater than or equal to about 0 mol %, greater than or equal to about 0.5 mol %, greater than or equal to about 1 mol %, greater than or equal to about 2 mol %, or even greater than or equal to about 3 mol %. In embodiments, the concentration of Y₂O₃ in the glass composition and the resultant glass article may be less than or equal to about 10 mol %, less than or equal to about 9.5 mol %, less than or equal to about 9 mol %, less than or equal to about 8.5 mol %, less than or equal to about 8 mol %, less than or equal to about 7.5 mol %, less than or equal to about 7 mol %, less than or equal to about 6.5 mol %, or even less than or equal to about 6 mol %. In embodiments, the concentration of Y₂O₃ in the glass composition and the resultant glass article may be greater than or equal to about 0 mol % and less than or equal to about 10 mol %, greater than or equal to about 0 mol % and less than or equal to about 9.5 mol %, greater than or equal to about 0 mol % and less than or equal to about 9 mol %, greater than or equal to about 0 mol % and less than or equal to about 8.5 mol %, greater than or equal to about 0 mol % and less than or equal to about 8 mol %, greater than or equal to about 0 mol % and less than or equal to about 7.5 mol %, greater than or equal to about 0 mol % and less than or equal to about 7 mol %, greater than or equal to about 0 mol % and less than or equal to about 6.5 mol %, greater than or equal to about 0 mol % and less than or equal to about 6 mol %, greater than or equal to about 0.5 mol % and less than or equal to about 10 mol %, greater than or equal to about 0.5 mol % and less than or equal to about 9.5 mol %, greater than or equal to about 0.5 mol % and less than or equal to about 9 mol %, greater than or equal to about 0.5 mol % and less than or equal to about 8.5 mol %, greater than or equal to about 0.5 mol % and less than or equal to about 8 mol %, greater than or equal to about 0.5 mol % and less than or equal to about 7.5 mol %, greater than or equal to about 0.5 mol % and less than or equal to about 7 mol %, greater than or equal to about 0.5 mol % and less than or equal to about 6.5 mol %, greater than or equal to about 0.5 mol % and less than or equal to about 6 mol %, greater than or equal to about 1 mol % and less than or equal to about 10 mol %, greater than or equal to about 1 mol % and less than or equal to about 9.5 mol %, greater than or equal to about 1 mol % and less than or equal to about 9 mol %, greater than or equal to about 1 mol % and less than or equal to about 8.5 mol %, greater than or equal to about 1 mol % and less than or equal to about 8 mol %, greater than or equal to about 1 mol % and less than or equal to about 7.5 mol %, greater than or equal to about 1 mol % and less than or equal to about 7 mol %, greater than or equal to about 1 mol % and less than or equal to about 6.5 mol %, greater than or equal to about 1 mol % and less than or equal to about 6 mol %, greater than or equal to about 2 mol % and less than or equal to about 10 mol %, greater than or equal to about 2 mol % and less than or equal to about 9.5 mol %, greater than or equal to about 2 mol % and less than or equal to about 9 mol %, greater than or equal to about 2 mol % and less than or equal to about 8.5 mol %, greater than or equal to about 2 mol % and less than or equal to about 8 mol %, greater than or equal to about 2 mol % and less than or equal to about 7.5 mol %, greater than or equal to about 2 mol % and less than or equal to about 7 mol %, greater than or equal to about 2 mol % and less than or equal to about 6.5 mol %, greater than or equal to about 2 mol % and less than or equal to about 6 mol %, greater than or equal to about 3 mol % and less than or equal to about 10 mol %, greater than or equal to about 3 mol % and less than or equal to about 9.5 mol %, greater than or equal to about 3 mol % and less than or equal to about 9 mol %, greater than or equal to about 3 mol % and less than or equal to about 8.5 mol %, greater than or equal to about 3 mol % and less than or equal to about 8 mol %, greater than or equal to about 3 mol % and less than or equal to about 7.5 mol %, greater than or equal to about 3 mol % and less than or equal to about 7 mol %, greater than or equal to about 3 mol % and less than or equal to about 6.5 mol %, or even greater than or equal to about 3 mol % and less than or equal to about 6 mol %, or any and all sub-ranges formed from any of these endpoints. In embodiments, the glass composition and the resultant glass article may be free or substantially free of Y₂O₃.

As noted hereinabove, Ta₂O₅ may increase the fracture toughness and Young's modulus of the glass composition and the resultant glass article described herein. In embodiments, the glass composition and the resultant glass article may comprise greater than or equal to about 0 mol % and less than or equal to about 9 mol % Ta₂O₅. In embodiments, the glass composition and the resultant glass article may comprise greater than or equal to about 0.5 mol % and less than or equal to about 9 mol % Ta₂O₅. In embodiments, the concentration of Ta₂O₅ in the glass composition and the resultant glass article may be greater than or equal to about 0 mol %, greater than or equal to about 0.5 mol %, greater than or equal to about 1 mol %, or even greater than or equal to about 2 mol %. In embodiments, the concentration of Ta₂O₅ in the glass composition and the resultant glass article may be less than or equal to about 9 mol %, less than or equal to about 8 mol %, less than or equal to about 7 mol %, less than or equal to about 6 mol %, or even less than or equal to 5 mol %. In embodiments, the concentration of Ta₂O₅ in the glass composition and the resultant glass article may be greater than or equal to about 0 mol % and less than or equal to about 9 mol %, greater than or equal to about 0 mol % and less than or equal to about 8 mol %, greater than or equal to about 0 mol % and less than or equal to about 7 mol %, greater than or equal to about 0 mol % and less than or equal to about 6 mol %, greater than or equal to about 0 mol % and less than or equal to about 5 mol %, greater than or equal to about 0.5 mol % and less than or equal to about 9 mol %, greater than or equal to about 0.5 mol % and less than or equal to about 8 mol %, greater than or equal to about 0.5 mol % and less than or equal to about 7 mol %, greater than or equal to about 0.5 mol % and less than or equal to about 6 mol %, greater than or equal to about 0.5 mol % and less than or equal to about 5 mol %, greater than or equal to about 1 mol % and less than or equal to about 9 mol %, greater than or equal to about 1 mol % and less than or equal to about 8 mol %, greater than or equal to about 1 mol % and less than or equal to about 7 mol %, greater than or equal to about 1 mol % and less than or equal to about 6 mol %, greater than or equal to about 1 mol % and less than or equal to about 5 mol %, greater than or equal to about 2 mol % and less than or equal to about 9 mol %, greater than or equal to about 2 mol % and less than or equal to about 8 mol %, greater than or equal to about 2 mol % and less than or equal to about 7 mol %, greater than or equal to about 2 mol % and less than or equal to about 6 mol %, or even greater than or equal to about 2 mol % and less than or equal to about 5 mol %, or any and all sub-ranges formed from any of these endpoints. In embodiments, the glass composition and the resultant glass article may be free or substantially free of Ta₂O₅.

As noted hereinabove, La₂O₃ may increase the fracture toughness and Young's modulus of the glass composition and the resultant glass article described herein. In embodiments, the glass composition and the resultant glass article may comprise greater than or equal to about 0 mol % and less than or equal to about 10 mol % La₂O₃. In embodiments, the glass composition and the resultant glass article may comprise greater than or equal to about 0.5 mol % and less than or equal to about 9.5 mol % La₂O₃. In embodiments, the concentration of La₂O₃ in the glass composition and the resultant glass article may be greater than or equal to about 0 mol %, greater than or equal to about 0.5 mol %, greater than or equal to about 1 mol %, greater than or equal to about 2 mol %, or even greater than or equal to about 3 mol %. In embodiments, the concentration of La₂O₃ in the glass composition and the resultant glass article may be less than or equal to about 10 mol %, less than or equal to about 9.5 mol %, less than or equal to about 9 mol %, less than or equal to about 8.5 mol %, less than or equal to about 8 mol %, less than or equal to about 7.5 mol %, less than or equal to about 7 mol %, less than or equal to about 6.5 mol %, or even less than or equal to about 6 mol %. In embodiments, the concentration of La₂O₃ in the glass composition and the resultant glass article may be greater than or equal to about 0 mol % and less than or equal to about 10 mol %, greater than or equal to about 0 mol % and less than or equal to about 9.5 mol %, greater than or equal to about 0 mol % and less than or equal to about 9 mol %, greater than or equal to about 0 mol % and less than or equal to about 8.5 mol %, greater than or equal to about 0 mol % and less than or equal to about 8 mol %, greater than or equal to about 0 mol % and less than or equal to about 7.5 mol %, greater than or equal to about 0 mol % and less than or equal to about 7 mol %, greater than or equal to about 0 mol % and less than or equal to about 6.5 mol %, greater than or equal to about 0 mol % and less than or equal to about 6 mol %, greater than or equal to about 0.5 mol % and less than or equal to about 10 mol %, greater than or equal to about 0.5 mol % and less than or equal to about 9.5 mol %, greater than or equal to about 0.5 mol % and less than or equal to about 9 mol %, greater than or equal to about 0.5 mol % and less than or equal to about 8.5 mol %, greater than or equal to about 0.5 mol % and less than or equal to about 8 mol %, greater than or equal to about 0.5 mol % and less than or equal to about 7.5 mol %, greater than or equal to about 0.5 mol % and less than or equal to about 7 mol %, greater than or equal to about 0.5 mol % and less than or equal to about 6.5 mol %, greater than or equal to about 0.5 mol % and less than or equal to about 6 mol %, greater than or equal to about 1 mol % and less than or equal to about 10 mol %, greater than or equal to about 1 mol % and less than or equal to about 9.5 mol %, greater than or equal to about 1 mol % and less than or equal to about 9 mol %, greater than or equal to about 1 mol % and less than or equal to about 8.5 mol %, greater than or equal to about 1 mol % and less than or equal to about 8 mol %, greater than or equal to about 1 mol % and less than or equal to about 7.5 mol %, greater than or equal to about 1 mol % and less than or equal to about 7 mol %, greater than or equal to about 1 mol % and less than or equal to about 6.5 mol %, greater than or equal to about 1 mol % and less than or equal to about 6 mol %, greater than or equal to about 2 mol % and less than or equal to about 10 mol %, greater than or equal to about 2 mol % and less than or equal to about 9.5 mol %, greater than or equal to about 2 mol % and less than or equal to about 9 mol %, greater than or equal to about 2 mol % and less than or equal to about 8.5 mol %, greater than or equal to about 2 mol % and less than or equal to about 8 mol %, greater than or equal to about 2 mol % and less than or equal to about 7.5 mol %, greater than or equal to about 2 mol % and less than or equal to about 7 mol %, greater than or equal to about 2 mol % and less than or equal to about 6.5 mol %, greater than or equal to about 2 mol % and less than or equal to about 6 mol %, greater than or equal to about 3 mol % and less than or equal to about 10 mol %, greater than or equal to about 3 mol % and less than or equal to about 9.5 mol %, greater than or equal to about 3 mol % and less than or equal to about 9 mol %, greater than or equal to about 3 mol % and less than or equal to about 8.5 mol %, greater than or equal to about 3 mol % and less than or equal to about 8 mol %, greater than or equal to about 3 mol % and less than or equal to about 7.5 mol %, greater than or equal to about 3 mol % and less than or equal to about 7 mol %, greater than or equal to about 3 mol % and less than or equal to about 6.5 mol %, or even greater than or equal to about 3 mol % and less than or equal to about 6 mol %, or any and all sub-ranges formed from any of these endpoints. In embodiments, the glass composition and the resultant glass article may be free or substantially free of La₂O₃.

In embodiments, the total concentration or sum of Y₂O₃, Ta₂O₅, and La₂O₃ (i.e., Y₂O₃ (mol %)+Ta₂O₅ (mol %)+La₂O₃ (mol %)) in the glass composition and the resultant glass article may be greater than or equal to about 2 mol % and less than or equal to about 15 mol % to increase the fracture toughness and Young's modulus of the glass composition and the resultant glass article. In embodiments, the total concentration of Y₂O₃, Ta₂O₅, and La₂O₃ in the glass composition and the resultant glass article may be greater than or equal to about 2 mol % and less than or equal to about 12 mol %. In embodiments, the total concentration of Y₂O₃, Ta₂O₅, and La₂O₃ in the glass composition and the resultant glass article may be greater than or equal to about 2 mol %, greater than or equal to about 3 mol %, greater than or equal to about 4 mol %, or even greater than or equal to about 5 mol %. In embodiments, the total concentration of Y₂O₃, Ta₂O₅, and La₂O₃ in the glass composition and the resultant glass article may be less than or equal to about 14 mol %, less than or equal to about 12 mol %, less than or equal to about 10 mol %, or even less than or equal to about 8 mol %. In embodiments, the total concentration of Y₂O₃, Ta₂O₅, and La₂O₃ in the glass composition and the resultant glass article may be greater than or equal to about 2 mol % and less than or equal to about 14 mol %, greater than or equal to about 2 mol % and less than or equal to about 12 mol %, greater than or equal to about 2 mol % and less than or equal to about 10 mol %, greater than or equal to about 2 mol % and less than or equal to about 8 mol %, greater than or equal to about 3 mol % and less than or equal to about 14 mol %, greater than or equal to about 3 mol % and less than or equal to about 12 mol %, greater than or equal to about 3 mol % and less than or equal to about 10 mol %, greater than or equal to about 3 mol % and less than or equal to about 8 mol %, greater than or equal to about 4 mol % and less than or equal to about 14 mol %, greater than or equal to about 4 mol % and less than or equal to about 12 mol %, greater than or equal to about 4 mol % and less than or equal to about 10 mol %, greater than or equal to about 4 mol % and less than or equal to about 8 mol %, greater than or equal to about 5 mol % and less than or equal to about 14 mol %, greater than or equal to about 5 mol % and less than or equal to about 12 mol %, greater than or equal to about 5 mol % and less than or equal to about 10 mol %, or even greater than or equal to about 5 mol % and less than or equal to about 8 mol %, or any and all sub-ranges formed from any of these endpoints.

In embodiments, the glass compositions and the resultant glass article may further comprise ZrO₂. Zirconia may impart improved mechanical properties, such as fracture toughness. Additions of zirconia may also improve the ion exchange performance, thereby increasing the depth of layer. In embodiments, the glass composition and resultant glass article may include greater than about 0 mol % and less than or equal to about 9 mol % ZrO₂. In embodiments, the concentration of ZrO₂ in the glass composition and resultant glass article may be greater than or equal to about 0 mol %, greater than or equal to about 1 mol %, greater than or equal to about 2 mol %, or even greater than or equal to about 3 mol %. In embodiments, the concentration of ZrO₂ in the glass composition and resultant glass article may be less than or equal to about 9 mol %, less than or equal to about 7 mol %, or even less than or equal to about 5 mol %. In embodiments, the concentration of ZrO₂ in the glass composition and resultant glass article disclosed herein may be greater than or equal to about 0 mol % and less than or equal to about 9 mol %, greater than or equal to about 0 mol % and less than or equal to about 7 mol %, greater than or equal to about 0 mol % and less than or equal to about 5 mol %, greater than or equal to about 1 mol % and less than or equal to about 9 mol %, greater than or equal to about 1 mol % and less than or equal to about 7 mol %, greater than or equal to about 1 mol % and less than or equal to about 5 mol %, greater than or equal to about 3 mol % and less than or equal to about 9 mol %, greater than or equal to about 3 mol % and less than or equal to about 7 mol %, or even greater than or equal to about 3 mol % and less than or equal to about 5 mol %, or any and all sub-ranges formed from any of these endpoints. In embodiments, the glass composition and the resultant glass article may be free or substantially free of ZrO₂.

In embodiments, the total concentration or sum of Al₂O₃ and ZrO₂ (i.e., Al₂O₃ (mol %)+ZrO₂ (mol %)) in the glass composition and the resultant glass article may be greater than or equal to about 2 mol % and less than or equal to about 12 mol % to impart improved fracture toughness and ion exchangeability to the glass composition and the resultant glass article. In embodiments, the total concentration of Al₂O₃ and ZrO₂ in the glass composition and the resultant glass article may be greater than or equal to about 2 mol % or even greater than or equal to about 4 mol %. In embodiments, the total concentration of Al₂O₃ and ZrO₂ in the glass composition and the resultant glass article may be less than or equal to about 12 mol %, less than or equal to about 10 mol %, less than or equal to about 8 mol %, or even less than or equal to about 6 mol %. In embodiments, the total concentration of Al₂O₃ and ZrO₂ in the glass composition and the resultant glass article may be greater than or equal to about 2 mol % and less than or equal to about 12 mol %, greater than or equal to about 2 mol % and less than or equal to about 10 mol %, greater than or equal to about 2 mol % and less than or equal to about 8 mol %, greater than or equal to about 2 mol % and less than or equal to about 6 mol %, greater than or equal to about 4 mol % and less than or equal to about 12 mol %, greater than or equal to about 4 mol % and less than or equal to about 10 mol %, greater than or equal to about 4 mol % and less than or equal to about 8 mol %, or even greater than or equal to about 4 mol % and less than or equal to about 6 mol %, or any and all sub-ranges formed from any of these endpoints.

The glass compositions described herein may further include one or more divalent oxides, such as MgO and ZnO. The divalent oxides improve the fracture toughness and melting behavior of the glass compositions. Additions of MgO and ZnO also improve the ion exchange performance of the glass composition. In particular, it has been found that additions of MgO and ZnO generally increase the compressive stress and depth of layer for a given ion exchange condition (time and temperature) without increasing the softening point of the glass composition.

In embodiments, the glass composition and the resultant glass article may comprise greater than 0 mol % and less than or equal to about 9 mol % MgO. In embodiments, the concentration of MgO in the glass composition and the resultant glass article may be greater than or equal to about 0 mol %, greater than or equal to about 1 mol %, greater than or equal to about 2 mol %, or even greater than or equal to about 3 mol %. In embodiments, the concentration of MgO in the glass composition and the resultant glass article may be less than or equal to about 9 mol %, less than or equal to about 8 mol %, less than or equal to about 7 mol %, or even less than or equal to about 6 mol %. In embodiments, the concentration of MgO in the glass composition and the resultant glass article may be greater than or equal to about 0 mol % and less than or equal to about 9 mol %, greater than or equal to about 0 mol % and less than or equal to about 8 mol %, greater than or equal to about 0 mol % and less than or equal to about 7 mol %, greater than or equal to about 0 mol % and less than or equal to about 6 mol %, greater than or equal to about 1 mol % and less than or equal to about 9 mol %, greater than or equal to about 1 mol % and less than or equal to about 8 mol %, greater than or equal to about 1 mol % and less than or equal to about 7 mol %, greater than or equal to about 1 mol % and less than or equal to about 6 mol %, greater than or equal to about 2 mol % and less than or equal to about 9 mol %, greater than or equal to about 2 mol % and less than or equal to about 8 mol %, greater than or equal to about 2 mol % and less than or equal to about 7 mol %, greater than or equal to about 2 mol % and less than or equal to about 6 mol %, greater than or equal to about 3 mol % and less than or equal to about 9 mol %, greater than or equal to about 3 mol % and less than or equal to about 8 mol %, greater than or equal to about 3 mol % and less than or equal to about 7 mol %, or even greater than or equal to about 3 mol % and less than or equal to about 6 mol %, or any and all sub-ranges formed from any of these endpoints. In embodiments, the glass composition and the resultant glass article may be free or substantially free of MgO.

In embodiments, the glass composition and the resultant glass article may comprise greater than 0 mol % and less than or equal to about 9 mol % ZnO. In embodiments, the concentration of ZnO in the glass composition and the resultant glass article may be greater than or equal to about 0 mol %, greater than or equal to about 1 mol %, greater than or equal to about 2 mol %, or even greater than or equal to about 3 mol %. In embodiments, the concentration of ZnO in the glass composition and the resultant glass article may be less than or equal to about 9 mol %, less than or equal to about 8 mol %, less than or equal to about 7 mol %, or even less than or equal to about 6 mol %. In embodiments, the concentration of ZnO in the glass compositions and the resultant glass article may be greater than or equal to about 0 mol % and less than or equal to about 9 mol %, greater than or equal to about 0 mol % and less than or equal to about 8 mol %, greater than or equal to about 0 mol % and less than or equal to about 7 mol %, greater than or equal to about 0 mol % and less than or equal to about 6 mol %, greater than or equal to about 1 mol % and less than or equal to about 9 mol %, greater than or equal to about 1 mol % and less than or equal to about 8 mol %, greater than or equal to about 1 mol % and less than or equal to about 7 mol %, greater than or equal to about 1 mol % and less than or equal to about 6 mol %, greater than or equal to about 2 mol % and less than or equal to about 9 mol %, greater than or equal to about 2 mol % and less than or equal to about 8 mol %, greater than or equal to about 2 mol % and less than or equal to about 7 mol %, greater than or equal to about 2 mol % and less than or equal to about 6 mol %, greater than or equal to about 3 mol % and less than or equal to about 9 mol %, greater than or equal to about 3 mol % and less than or equal to about 8 mol %, greater than or equal to about 3 mol % and less than or equal to about 7 mol %, or even greater than or equal to about 3 mol % and less than or equal to about 6 mol %, or any and all sub-ranges formed from any of these endpoints. In embodiments, the glass composition and the resultant glass article may be free or substantially free of ZnO.

In embodiments, the total concentration or sum of ZrO₂, MgO, and ZnO (i.e., ZrO₂ (mol %)+MgO (mol %)+ZnO (mol %)) in the glass composition and the resultant glass article may be greater than or equal to about 2 mol % and less than or equal to about 14 mol % to impart improved fracture toughness and ion exchangeability to the glass composition and the resultant glass article. In embodiments, the total concentration of ZrO₂, MgO, and ZnO in the glass composition and the resultant glass article may be greater than or equal to about 2 mol %, greater than or equal to about 4 mol %, or even greater than or equal to about 6 mol %. In embodiments, the total concentration of ZrO₂, MgO, and ZnO in the glass composition and the resultant glass article may be less than or equal to about 14 mol %, less than or equal to about 12 mol %, or even less than or equal to about 10 mol %. In embodiments, the total concentration of ZrO₂, MgO, and ZnO in the glass composition and the resultant glass article may be greater than or equal to about 2 mol % and less than or equal to about 14 mol %, greater than or equal to about 2 mol % and less than or equal to about 12 mol %, greater than or equal to about 2 mol % and less than or equal to about 10 mol %, greater than or equal to about 4 mol % and less than or equal to about 14 mol %, greater than or equal to about 4 mol % and less than or equal to about 12 mol %, greater than or equal to about 4 mol % and less than or equal to about 10 mol %, greater than or equal to about 6 mol % and less than or equal to about 14 mol %, greater than or equal to about 6 mol % and less than or equal to about 12 mol %, or even greater than or equal to about 6 mol % and less than or equal to about 10 mol %, or any and all sub-ranges formed from any of these endpoints.

In embodiments, the glass compositions and the resultant glass article described herein may further include one or more fining agents. In embodiments, the fining agents may include, for example, SnO₂. In embodiments, the glass composition and the resultant glass article may comprise greater than about 0.05 mol % and less than or equal to about 1 mol % SnO₂. In embodiments, the glass composition and the resultant glass article may comprise greater than about 0.05 mol % and less than or equal to about 0.5 mol % SnO₂. In embodiments, the concentration of SnO₂ in the glass composition and the resultant glass article may be greater than or equal to about 0.05 mol %, or even greater than or equal to about 0.1 mol %. In embodiments, the concentration of SnO₂ in the glass composition and the resultant glass article may be less than or equal to about 1 mol %, less than or equal to about 0.5 mol %, or even less than or equal to about 0.25 mol %. In embodiments, the concentration of SnO₂ in the glass composition and the resultant glass article may be greater than or equal to about 0.05 mol % and less than or equal to about 1 mol %, greater than or equal to about 0.05 mol % and less than or equal to about 0.5 mol %, greater than or equal to about 0.05 mol % and less than or equal to about 0.25 mol %, greater than or equal to about 0.1 mol % and less than or equal to about 1 mol %, greater than or equal to about 0.1 mol % and less than or equal to about 0.5 mol %, or even greater than or equal to about 0.1 mol % and less than or equal to about 0.25 mol %, or any and all sub-ranges formed from any of these endpoints. In embodiments, the glass composition and the resultant glass article may be substantially free of SnO₂.

In embodiments, the glass compositions described herein may further include tramp materials such as FeO, Fe₂O₃, MnO, MoO₃, CdO, As₂O₃, Sb₂O₃, sulfur-based compounds, such as sulfates, halogens, or combinations thereof.

According to embodiments, the glass composition and resultant glass article may comprise: greater than or equal to about 70 mol % and less than or equal to about 90 mol % SiO₂; greater than or equal to about 2 mol % and less than or equal to about 9 mol % Al₂O₃; greater than or equal to about 5 mol % and less than or equal to about 15 mol % Li₂O; greater than or equal to about 0 mol % and less than or equal to about 10 mol % Y₂O₃; greater than or equal to about 0 mol % and less than or equal to about 9 mol % Ta₂O₅; and greater than or equal to about 0 mol % and less than or equal to about 10 mol % La₂O₃, and greater than or equal to about 0.05 mol % and less than or equal to about 0.2 mol % SnO₂, wherein the sum of Y₂O₃, Ta₂O₅, and La₂O₃ (i.e., Y₂O₃+Ta₂O₅+La₂O₃) in the glass composition and the resultant glass article is greater than or equal to about 2 mol % and less than or equal to about 15%.

The articles formed from the glass compositions described herein may be any suitable shape or thickness, which may vary depending on the particular application for use of the glass composition. Glass sheet embodiments may have a thickness greater than or equal to about 30 μm, greater than or equal to about 50 μm, greater than or equal to about 100 μm, greater than or equal to about 250 μm, greater than or equal to about 500 μm, greater than or equal to about 750 μm, or even greater than or equal to about 1 mm. In embodiments, the glass sheet embodiments may have a thickness less than or equal to about 6 mm, less than or equal to about 5 mm, less than or equal to about 4 mm, less than or equal to about 3 mm, or even less than or equal to about 2 mm. In embodiments, the glass sheet embodiments may have a thickness greater than or equal to about 30 μm and less than or equal to about 6 mm, greater than or equal to about 30 μm and less than or equal to about 5 mm, greater than or equal to about 30 μm and less than or equal to about 4 mm, greater than or equal to about 30 μm and less than or equal to about 3 mm, greater than or equal to about 30 μm and less than or equal to about 2 mm, greater than or equal to about 50 μm and less than or equal to about 6 mm, greater than or equal to about 50 μm and less than or equal to about 5 mm, greater than or equal to about 50 μm and less than or equal to about 4 mm, greater than or equal to about 50 μm and less than or equal to about 3 mm, greater than or equal to about 50 μm and less than or equal to about 2 mm, greater than or equal to about 100 μm and less than or equal to about 6 mm, greater than or equal to about 100 μm and less than or equal to about 5 mm, greater than or equal to about 100 μm and less than or equal to about 4 mm, greater than or equal to about 100 μm and less than or equal to about 3 mm, greater than or equal to about 100 μm and less than or equal to about 2 mm, greater than or equal to about 250 μm and less than or equal to about 6 mm, greater than or equal to about 250 μm and less than or equal to about 5 mm, greater than or equal to about 250 μm and less than or equal to about 4 mm, greater than or equal to about 250 μm and less than or equal to about 3 mm, greater than or equal to about 250 μm and less than or equal to about 2 mm, greater than or equal to about 500 μm and less than or equal to about 6 mm, greater than or equal to about 500 μm and less than or equal to about 5 mm, greater than or equal to about 500 μm and less than or equal to about 4 mm, greater than or equal to about 500 μm and less than or equal to about 3 mm, greater than or equal to about 500 μm and less than or equal to about 2 mm, greater than or equal to about 750 μm and less than or equal to about 6 mm, greater than or equal to about 750 μm and less than or equal to about 5 mm, greater than or equal to about 750 μm and less than or equal to about 4 mm, greater than or equal to about 750 μm and less than or equal to about 3 mm, greater than or equal to about 750 μm and less than or equal to about 2 mm, greater than or equal to about 1 mm and less than or equal to about 6 mm, greater than or equal to about 1 mm and less than or equal to about 5 mm, greater than or equal to about 1 mm and less than or equal to about 4 mm, greater than or equal to about 1 mm and less than or equal to about 3 mm, or even greater than or equal to about 1 mm and less than or equal to about 2 mm, or any and all sub-ranges formed from any of these endpoints.

As discussed hereinabove, the glass compositions and the resultant glass articles described herein may have increased Young's modulus such that the glass compositions and the resultant glass articles are more elastic. In embodiments, the glass composition and the resultant glass article may have a Young's modulus greater than or equal to about 60 GPa, greater than or equal to about 65 GPa, greater than or equal to about 70 GPa, or even greater than or equal to 75 GPa. In embodiments, the glass composition and the resultant glass article may have a Young's modulus less than or equal to about 110 GPa, less than or equal to about 100 GPa, or even less than or equal to about 90 GPa. In embodiments, the glass composition and the resultant glass article may have a Young's modulus greater than or equal to about 60 GPa and less than or equal to about 110 GPa, greater than or equal to about 60 GPa and less than or equal to about 100 GPa, greater than or equal to about 60 GPa and less than or equal to about 90 GPa, greater than or equal to about 65 GPa and less than or equal to about 110 GPa, greater than or equal to about 65 GPa and less than or equal to about 100 GPa, greater than or equal to about 65 GPa and less than or equal to about 90 GPa, greater than or equal to about 70 GPa and less than or equal to about 110 GPa, greater than or equal to about 70 GPa and less than or equal to about 100 GPa, greater than or equal to about 70 GPa and less than or equal to about 90 GPa, greater than or equal to about 75 GPa and less than or equal to about 110 GPa, greater than or equal to about 75 GPa and less than or equal to about 100 GPa, or even greater than or equal to about 75 GPa and less than or equal to about 90 GPa, or any and all sub-ranges formed from any of these endpoints.

As discussed hereinabove, the glass composition and the resultant glass article described herein may have increased fracture toughness such that the glass composition and the resultant glass article are more resistant to damage. In embodiments, the glass composition and the resultant glass article may have a K_{Ic} fracture toughness of greater than or equal to about 0.7 MPa·m^{1/2}, greater than or equal to about 0.8 MPa·m^{1/2}, or even greater than or equal to about 0.9 MPa·m^{1/2}.

In embodiments, the glass composition and the resultant glass article may have a density greater than or equal to about 2.2 g/cm³, greater than or equal to about 2.3 g/cm³, or even greater than or equal to about 2.4 g/cm³. In embodiments, the glass composition and the resultant glass article may have a density less than or equal to about 2.9 g/cm³, less than or equal to about 2.8 g/cm³, or even less than or equal to about 2.7 g/cm³. In embodiments, the glass composition and the resultant glass article may have a density greater than or equal to about 2.2 g/cm³ and less than or equal to about 2.9 g/cm³, greater than or equal to about 2.2 g/cm³ and less than or equal to about 2.8 g/cm³, greater than or equal to about 2.2 g/cm³ and less than or equal to about 2.7 g/cm³, greater than or equal to about 2.3 g/cm³ and less than or equal to about 2.9 g/cm³, greater than or equal to about 2.3 g/cm³ and less than or equal to about 2.8 g/cm³, greater than or equal to about 2.3 g/cm³ and less than or equal to about 2.7 g/cm³, greater than or equal to about 2.4 g/cm³ and less than or equal to about 2.9 g/cm³, greater than or equal to about 2.4 g/cm³ and less than or equal to about 2.8 g/cm³, or even greater than or equal to about 2.4 g/cm³ and less than or equal to about 2.7 g/cm³, or any and all sub-ranges formed from any of these endpoints.

In embodiments, the glass composition and the resultant glass article may have a strain point greater than or equal to about 500° C., greater than or equal to about 550° C., or even greater than or equal to about 600° C. In embodiments, the glass composition and the resultant glass article may have a strain point less than or equal to about 800° C., less than or equal to about 750° C., less than or equal to about 700° C. In embodiments, the glass composition and the resultant glass article may have a strain point greater than or equal to about 500° C. and less than or equal to about 800° C., greater than or equal to about 500° C. and less than or equal to about 750° C., greater than or equal to about 500° C. and less than or equal to about 700° C., greater than or equal to about 550° C. and less than or equal to about 800° C., greater than or equal to about 550° C. and less than or equal to about 750° C., greater than or equal to about 550° C. and less than or equal to about 700° C., greater than or equal to about 600° C. and less than or equal to about 800° C., greater than or equal to about 600° C. and less than or equal to about 750° C., or even greater than or equal to about 600° C. and less than or equal to about 700° C., or any and all sub-ranges formed from any of these endpoints.

In embodiments, the glass composition and the resultant glass article may have an annealing point greater than or equal to about 500° C. or even greater than or equal to about 550° C. In embodiments, the glass composition and the resultant glass article may have an annealing point less than or equal to about 800° C. or even less than or equal to about 700° C. In embodiments, the glass composition and the resultant glass article may have an annealing point greater than or equal to about 500° C. and less than or equal to about 800° C., greater than or equal to about 500° C. and less than or equal to about 700° C., greater than or equal to about 550° C. and less than or equal to about 800° C., or even greater than or equal to about 550° C. and less than or equal to about 700° C., or any and all sub-ranges formed from any of these endpoints.

In embodiments, the glass composition and the resultant glass article may have a shear modulus greater than or equal to about 20 GPa, greater than or equal to about 25 GPa, or even greater than or equal to about 30 GPa. In embodiments, the glass composition and the resultant glass article may have a shear modulus less than or equal to about 50 GPa, less than or equal to about 45 GPa, or even less than or equal to about 40 GPa. In embodiments, the glass composition and the resultant glass article may have a shear modulus greater than or equal to about 20 GPa and less than or equal to about 50 GPa, greater than or equal to about 20 GPa and less than or equal to about 45 GPa, greater than or equal to about 20 GPa and less than or equal to about 40 GPa, greater than or equal to about 25 GPa and less than or equal to about 50 GPa, greater than or equal to about 25 GPa and less than or equal to about 45 GPa, greater than or equal to about 25 GPa and less than or equal to about 40 GPa, greater than or equal to about 30 GPa and less than or equal to about 50 GPa, greater than or equal to about 30 GPa and less than or equal to about 45 GPa, or even greater than or equal to about 30 GPa and less than or equal to about 40 GPa, or any and all sub-ranges formed from any of these endpoints.

In embodiments, the glass composition and the resultant glass article described herein may have a Poisson's ratio of greater than or equal to about 0.18 or even greater than or equal to about 0.19. In embodiments, the glass composition and the resultant glass article may have a Poisson's ratio less than or equal to about 0.25, less than or equal to about 0.24, or even less than or equal to about 0.23. In embodiments, the glass composition and the resultant glass article may have a Poisson's ratio greater than or equal to about 0.18 and less than or equal to about 0.25, greater than or equal to about 0.18 and less than or equal to about 0.24, greater than or equal to about 0.18 and less than or equal to about 0.23, greater than or equal to about 0.19 and less than or equal to about 0.25, greater than or equal to about 0.19 and less than or equal to about 0.24, or even greater than or equal to about 0.19 and less than or equal to about 0.23, or any and all sub-ranges formed from any of these endpoints.

In embodiments, the glass composition and the resultant glass article may have a refractive index greater than or equal to about 1.4, greater than or equal to about 1.6, or even greater than or equal to about 1.8. In embodiments, the glass composition and the resultant glass article may have a refractive index less than or equal to about 3.0, less than or equal to about 2.8, or even less than or equal to about 2.6. In embodiments, the glass composition and the resultant glass article may have a refractive index greater than or equal to about 1.4 and less than or equal to about 3.0, greater than or equal to about 1.4 and less than or equal to about 2.8, greater than or equal to about 1.4 and less than or equal to about 2.6, greater than or equal to about 1.6 and less than or equal to about 3.0, greater than or equal to about 1.6 and less than or equal to about 2.8, greater than or equal to about 1.6 and less than or equal to about 2.6, greater than or equal to about 1.8 and less than or equal to about 3.0, greater than or equal to about 1.8 and less than or equal to about 2.8, or even greater than or equal to about 1.8 and less than or equal to about 2.6, or any and all sub-ranges formed from any of these endpoints.

In embodiments, the glass composition and the resultant glass article may have a stress optical coefficient (“SOC”) greater than or equal to about 2.5 nm/mm/MPa or even greater than or equal to about 3.0 nm/mm/MPa. In embodiments, the glass composition and the resultant glass article may have a SOC less than or equal to about 4.0 nm/mm/MPa or even less than or equal to about 3.5 nm/mm/MPa. In embodiments, the glass composition and the resultant glass article may have a SOC greater than or equal to about 2.5 nm/mm/MPa and less than or equal to about 4.0 nm/mm/MPa, greater than or equal to about 2.5 nm/mm/MPa and less than or equal to about 3.5 nm/mm/MPa, greater than or equal to about 3.0 nm/mm/MPa and less than or equal to about 4.0 nm/mm/MPa, or even greater than or equal to about 3.0 nm/mm/MPa and less than or equal to about 3.5 nm/mm/MPa, or any and all sub-ranges formed from any of these endpoints.

In embodiments, the glass composition and the resultant glass article may have a CTE greater than or equal to about 30×10⁻⁷/° C. or even greater than or equal to about 40×10⁻⁷/° C. In embodiments, the glass composition and the resultant glass article may have a CTE less than or equal to about 70×10⁻⁷/° C. or even less than or equal to about 60×10⁻⁷/° C. In embodiments, the glass composition and the resultant glass article may have a CTE of greater than or equal to about 30×10⁻⁷/° C. and less than or equal to about 70×10⁻⁷/° C., greater than or equal to about 30×10⁻⁷/° C. and less than or equal to about 60×10⁻⁷/° C., greater than or equal to about 40×10⁻⁷/° C. and less than or equal to about 70×10⁻⁷/° C., or even greater than or equal to about 40×10⁻⁷/° C. and less than or equal to about 60×10⁻⁷/° C., or any and all sub-ranges formed from any of these endpoints.

In embodiments, the glass composition and the resultant glass article may have a liquidus temperature greater than or equal to about 1100° C. and less than or equal to about 1600° C. In embodiments, the glass composition and the resultant glass article may have a liquidus temperature greater than or equal to about 1100° C., greater than or equal to about 1200° C., greater than or equal to about 1300° C., or even greater than or equal to about 1400° C. In embodiments, the glass composition and the resultant glass article may have a liquidus temperature less than or equal to about 1600° C. or even less than or equal to about 1500° C. In embodiments, the glass composition and the resultant glass article may have a liquidus temperature greater than or equal to about 1100° C. and less than or equal to about 1600° C., greater than or equal to about 1100° C. and less than or equal to about 1500° C., greater than or equal to about 1200° C. and less than or equal and about 1600° C., greater than or equal to about 1200° C. and less than or equal to about 1500° C., greater than or equal to about 1300° C. and less than or equal to about 1600° C., greater than or equal to about 1300° C. and less than or equal to about 1500° C., greater than or equal to about 1400° C. and less than or equal to about 1600° C., or even greater than or equal to about 1400° C. and less than or equal to about 1500° C., or any and all sub-ranges formed from any of these endpoints.

In embodiments, the method for forming a glass article includes heat treating the glass composition as described herein at one or more preselected temperatures for one or more preselected times to melt the glass composition and cooling the glass composition. In embodiments, the heat treatment for making a glass article may include (i) heating a glass composition at a rate of about 1-100° C./min to glass melting temperature; (ii) maintaining the glass composition at the glass melting temperature for a time greater than or equal to about 4 hours and less than or equal to about 100 hours to produce a glass article; and (iii) cooling the formed glass article to room temperature. In embodiments, the glass melting temperature may be greater than or equal to about 1500° C. and less than or equal to about 1700° C.

In embodiments, the glass compositions described herein are ion exchangeable to facilitate strengthening the glass articles made from the glass compositions. In typical ion exchange processes, smaller metal ions in the glass article are replaced or “exchanged” with larger metal ions of the same valence within a layer that is close to the outer surface of the glass article. The replacement of smaller ions with larger ions creates a compressive stress within the layer of the glass article. In embodiments, the metal ions are monovalent metal ions (e.g., Li⁺, Na⁺, K⁺, and the like), and ion exchange is accomplished by immersing the glass article in a bath comprising at least one molten salt of the larger metal ion that is to replace the smaller metal ion in the glass article. Alternatively, other monovalent ions such as Ag⁺, Tl⁺, Cu⁺, and the like may be exchanged for monovalent ions. The ion exchange process or processes that are used to strengthen the glass article may include, but are not limited to, immersion in a single bath or multiple baths of like or different compositions with washing and/or annealing steps between immersions.

Upon exposure to the glass article, the ion exchange solution (e.g., KNO₃ and/or NaNO₃ molten salt bath) may, according to embodiments, be at a temperature greater than or equal to about 350° C. and less than or equal to about 500° C., greater than or equal to about 360° C. and less than or equal to about 450° C., greater than or equal to about 370° C. and less than or equal to about 440° C., greater than or equal to about 360° C. and less than or equal to about 420° C., greater than or equal to about 370° C. and less than or equal to about 400° C., greater than or equal to about 375° C. and less than or equal to about 475° C., greater than or equal to about 400° C. and less than or equal to about 500° C., greater than or equal to about 410° C. and less than or equal to about 490° C., greater than or equal to about 420° C. and less than or equal to about 480° C., greater than or equal to about 430° C. and less than or equal to about 470° C., or even greater than or equal to about 440° C. and less than or equal to about 460° C., or any and all sub-ranges between the foregoing values.

In embodiments, the glass article may be exposed to the ion exchange solution for a duration greater than or equal to about 1 hour and less than or equal to about 24 hours, greater than or equal to about 1 hour and less than or equal to about 18 hours, greater than or equal to about 1 hour and less than or equal to about 12 hours, greater than or equal to about 1 hour and less than or equal to about 6 hours, greater than or equal to about 2 hours and less than or equal to about 24 hours, greater than or equal to about 2 hours and less than or equal to about 18 hours, greater than or equal to about 2 hours and less than or equal to about 12 hours, greater than or equal to about 2 hours and less than or equal to about 6 hours, greater than or equal to about 4 hours and less than or equal to about 24 hours, greater than or equal to about 4 hours and less than or equal to about 18 hours, or even greater than or equal to about 4 hours and less than or equal to about 12 hours, greater than or equal to about 4 hours and less than or equal to about 6 hours, or any and all sub-ranges formed from any of these endpoints.

In embodiments, the relatively increased K_{Ic} fracture toughness of the glass compositions described herein enables improved stress profiles (e.g., depth of compression and maximum central tension) for the resultant glass articles, leading to improved mechanical performance.

In embodiments, the glass article may have a thickness t and a depth of compression, after ion exchange strengthening greater than or equal to about 0.075t. In embodiments, the glass article may have a thickness t and a depth of compression, after ion exchange strengthening, greater than or equal to about 0.075t, greater than or equal to about 0.1t, or even greater than or equal to about 0.2t. In embodiments, the glass article may have a thickness t and a depth of compression, after ion exchange strengthening, less than or equal to about 0.4t or even less than or equal to about 0.3t. In embodiments, the glass article may have a thickness t and a depth of compression, after ion exchange strengthening, greater than or equal to about 0.075t and less than or equal to about 0.4t, greater than or equal to about 0.075t and less than or equal to about 0.3t, greater than or equal to about 0.1t and less than or equal to about 0.4t, greater than or equal to about 0.1t and less than or equal to about 0.3t, greater than or equal to about 0.2t and less than or equal to about 0.4t, or even greater than or equal to about 0.2t and less than or equal to about 0.3t, or any and all sub-ranges formed from any of these endpoints.

In embodiments, the glass articles made from the glass compositions may have a depth of compression, after ion exchange strengthening, greater than or equal to about 50 μm, greater than or equal to about 75 μm, or even greater than or equal to about 100 μm. In embodiments, the glass articles made from the glass compositions may have a depth of compression, after ion exchange strengthening, less than or equal to about 200 μm or even less than or equal to about 150 μm. In embodiments, the glass articles made from the glass compositions may have a depth of compression, after ion exchange strengthening, greater than or equal to about 50 μm and less than or equal to about 200 μm, greater than or equal to about 50 μm and less than or equal to about 150 μm, greater than or equal to about 75 μm and less than or equal to about 200 μm, greater than or equal to about 75 μm and less than or equal to about 150 μm, greater than or equal to about 100 μm and less than or equal to about 200 μm, or even greater than or equal to about 100 μm and less than or equal to about 150 μm, or any and all sub-ranges formed from any of these endpoints.

In embodiments, the glass articles made from the glass compositions may have a maximum central tension, after ion exchange strengthening, greater than or equal to about 75 MPa, greater than or equal to about 100 MPa, greater than or equal to about 125 MPa, or even greater than or equal to about 150 MPa, as measured at an article thickness of 0.6 mm. In embodiments, the glass articles made from the glass compositions may have a maximum central tension, after ion exchange strengthening, less than or equal to about 300 MPa, less than or equal to about 250 MPa, or even less than or equal to about 200 MPa, as measured at an article thickness of 0.6 mm. In embodiments, the glass articles made from the glass compositions may have a maximum central tension, after ion exchange strengthening, greater than or equal to about 75 MPa and less than or equal to about 300 MPa, greater than or equal to about 75 MPa and less than or equal to about 250 MPa, greater than or equal to about 75 MPa and less than or equal to about 200 MPa, greater than or equal to about 100 MPa and less than or equal to about 300 MPa, greater than or equal to about 100 MPa and less than or equal to about 250 MPa, greater than or equal to about 100 MPa and less than or equal to about 200 MPa, greater than or equal to about 125 MPa and less than or equal to about 300 MPa, greater than or equal to about 125 MPa and less than or equal to about 250 MPa, greater than or equal to about 125 MPa and less than or equal to about 200 MPa, greater than or equal to about 150 MPa and less than or equal to about 300 MPa, greater than or equal to about 150 MPa and less than or equal to about 250 MPa, greater than or equal to about 150 MPa and less than or equal to about 200 MPa, or any and all sub-ranges formed from any of these endpoints, as measured at an article thickness of 0.6 mm.

The glass articles described herein have relatively high K_{Ic} fracture toughness and relatively high Young's modulus, leading to a high stored strain energy. In embodiments, the glass articles made from the glass compositions may have a stored strain energy, after ion exchange strengthening, greater than or equal to about 10 J/m², greater than or equal to about 20 J/m², or greater than or equal to about 30 J/m² and the glass article may be non-frangible.

The glass composition and resultant glass article described herein may be used for a variety of applications including, for example, for cover glass or glass backplane applications in consumer or commercial electronic devices including, for example, LCD and LED displays, computer monitors, and automated teller machines (ATMs); for touch screen or touch sensor applications, for portable electronic devices including, for example, mobile telephones, personal media players, watches and tablet computers; for integrated circuit applications including, for example, semiconductor wafers; for photovoltaic applications; for architectural glass applications; for automotive or vehicular glass applications; or for commercial or household appliance applications. In embodiments, a consumer electronic device (e.g., smartphones, tablet computers, watches, personal computers, ultrabooks, televisions, and cameras), an architectural glass, and/or an automotive glass may comprise a glass article as described herein.

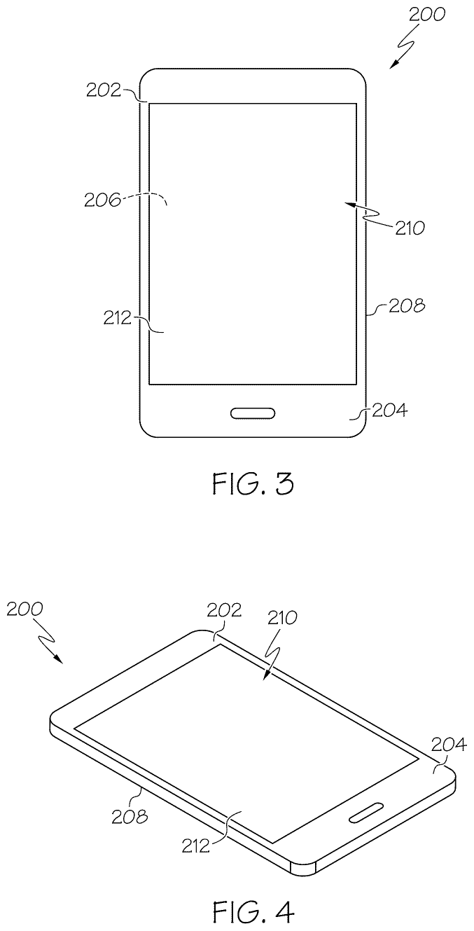

An exemplary electronic device incorporating any of the glass articles disclosed herein is shown in FIGS. 3 and 4. Specifically, FIGS. 3 and 4 show a consumer electronic device 200 including a housing 202 having front 204, back 206, and side surfaces 108; electrical components (not shown) that are at least partially inside or entirely within the housing and including at least a controller, a memory, and a display 210 at or adjacent to the front surface of the housing; and a cover substrate 212 at or over the front surface of the housing such that it is over the display. In embodiments, at least a portion of at least one of the cover substrate 212 and the housing 202 may include any of the glass articles disclosed herein.

### Examples

In order that various embodiments be more readily understood, reference is made to the following examples, which are intended to illustrate various embodiments of the glass compositions described herein.

Table 1 shows example glass compositions and a comparative glass composition (in terms of mol %) and the respective properties of the glass compositions. Glass articles were formed from the example glass compositions E1-E9 and comparative glass composition C1.

TABLE 1

| Example | C1 | E1 | E2 | E3 | E4 |
|---|---|---|---|---|---|
| SiO₂ | 84.6 | 81.2 | 78.1 | 74.8 | 83.7 |
| Al₂O₃ | 5.5 | 5.4 | 5.4 | 5.5 | 5.2 |
| Li₂O | 9.8 | 10.2 | 10.3 | 10.5 | 8.5 |
| SnO₂ | 0.1 | 0.1 | 0.1 | 0.1 | 0.1 |
| Y₂O₃ | — | 3.1 | 6.0 | 9.2 | — |
| Ta₂O₅ | — | — | — | — | 2.5 |
| La₂O₃ | — | — | — | — | — |
| Total | 100.0 | 100.0 | 100.0 | 100.0 | 100.0 |
| R₂O—Al₂O₃ | 4.3 | 4.8 | 4.9 | 5.0 | 3.3 |
| Al₂O₃ + ZrO₂ | 5.5 | 5.4 | 5.4 | 5.5 | 5.2 |
| Y₂O₃ + Ta₂O₅ + La₂O₃ | 0.0 | 3.1 | 6.0 | 9.2 | 2.5 |
| Density (g/cm³) | 2.293 | 2.467 | 2.671 | 2.831 | — |
| Anneal Pt. (° C.) | 574.2 | 649.3 | 670.2 | 723.3 | 704.0 |
| Strain Pt. (° C.) | 525.0 | 601.3 | 622.2 | 677.4 | 653.8 |
| Young's Modulus (GPa) | 76.26 | 81.57 | 87.29 | 91.77 | 87.36 |
| Shear Modulus (GPa) | 32.54 | 34.13 | 35.99 | 37.51 | 36.75 |
| Poisson's Ratio | 0.172 | 0.196 | 0.213 | 0.222 | 0.189 |
| K_{Ic} (CN) (MPa · m^{1/2}) | 0.780 | 0.840 | 0.920 | 0.940 | 0.810 |
| Refractive Index (at 589.3 nm) | 1.4914 | 2.467 | 2.671 | 2.831 | 1.5341 |
| SOC (nm/mm/MPa) | 3.155 | 2.996 | 3.161 | 3.161 | 3.377 |
| CTE (×10⁻⁷/° C.) | 41.9 | 48.4 | 55.4 | 58.0 | 40.2 |
| Liquidus Temperature (° C.) | — | — | — | — | 1240 |
| Primary Liquidus Phase | — | — | — | — | Cristobalite |
| Secondary Liquidus Phase | — | — | — | — | — |

| Example | E5 | E6 | E7 | E8 | E9 |
|---|---|---|---|---|---|
| SiO₂ | 82.7 | 81.4 | 81.2 | 78.3 | 75.2 |
| Al₂O₃ | 4.4 | 4.1 | 5.6 | 5.3 | 5.5 |
| Li₂O | 8.2 | 7.9 | 10.1 | 10.3 | 10.3 |
| SnO₂ | 0.1 | — | 0.1 | 0.1 | 0.1 |
| Y₂O₃ | — | — | — | — | — |
| Ta₂O₅ | 4.7 | 6.6 | — | — | — |
| La₂O₃ | — | — | 3.1 | 5.9 | 9.0 |
| Total | 100.0 | 100.0 | 100.0 | 100.0 | 100.0 |
| R₂O—Al₂O₃ | 3.8 | 3.8 | 4.5 | 5.0 | 4.8 |
| Al₂O₃ + ZrO₂ | 4.4 | 4.1 | 5.6 | 5.3 | 5.5 |
| Y₂O₃ + Ta₂O₅ + La₂O₃ | 4.7 | 6.6 | 3.1 | 5.9 | 9.0 |
| Density (g/cm³) | — | — | — | — | — |
| Anneal Pt. (° C.) | 741.2 | 750.1 | 600.4 | 598.7 | — |
| Strain Pt. (° C.) | 693.3 | 702.6 | 552.6 | 551.1 | — |
| Young's Modulus (GPa) | 92.60 | 81.22 | 84.60 | 89.91 | 83.98 |
| Shear Modulus (GPa) | 38.89 | 33.92 | 34.96 | 36.47 | 35.37 |
| Poisson's Ratio | 0.191 | 0.197 | 0.211 | 0.232 | 0.188 |
| K_{Ic} (CN) (MPa · m^{1/2}) | 0.870 | 0.920 | 0.860 | 0.910 | — |
| Refractive Index (at 589.3 nm) | 1.5761 | 1.6147 | 1.5721 | 1.5661 | — |
| SOC (nm/mm/MPa) | 3.505 | 3.763 | 2.835 | — | — |
| CTE (×10⁻⁷/° C.) | 39.6 | 39.1 | 50.5 | 59.2 | — |
| Liquidus Temperature (° C.) | 1315 | 1330 | 1280 | 1400 | 1450 |
| Primary Liquidus Phase | LiTaO | LiTaO | La | La | La |
| Secondary Liquidus Phase | — | — | Silicate | Silicate | Silicate |

As indicated by the example glass compositions in Table 1, the glass compositions and the resultant glass articles described herein have increased K_{Ic} fracture toughness such that the glass compositions and the resultant glass articles are more resistant to damage. Additionally, the glass compositions and the resultant glass articles described herein have a higher Young's modulus such that the compositions and the resultant glass articles are more elastic.

Table 2 shows the CT of comparative ion exchanged glass article CA1 and example ion exchanged glass articles EA1 and EA2 formed by ion exchanging glass articles having a thickness of 0.6 mm and made from a comparative glass composition and example glass compositions, as indicated in Table 2, at a temperature of 450° C. for 2 or 4 hours. The ion exchange solution was a 100% NaNO₃ molten salt bath.

TABLE 2

| Example | CA1 | EA1 | EA2 |
|---|---|---|---|
| Composition | C1 | E2 | E5 |
| Ion Exchange Time Period (hours) | 4 | 4 | 2 |
| Depth of Compression (μm) | 133.74 | 108.05 | 133.32 |
| Max. Central Tension (MPa) | 70.17 | 109.66 | 194.52 |
| SSE (J/m²) | 9.08 | 23.19 | 51.64 |

As indicated by the example ion exchanged glass articles in Table 2, glass articles formed from the glass compositions having increased K_{Ic} fracture toughness as described herein may be ion exchanged to achieve a desired stress profile and stored strain energy.

It will be apparent to those skilled in the art that various modifications and variations may be made to the embodiments described herein without departing from the spirit and scope of the claimed subject matter. Thus, it is intended that the specification cover the modifications and variations of the various embodiments described herein provided such modification and variations come within the scope of the appended claims and their equivalents.

1. A glass composition comprising:
greater than or equal to about 70 mol % and less than or equal to about 90 mol % SiO2;
greater than or equal to about 2 mol % and less than or equal to about 9 mol % Al2O3;
greater than or equal to about 5 mol % and less than or equal to about 15 mol % Li2O;
greater than or equal to about 0 mol % and less than or equal to about 10 mol % Y2O3;
greater than or equal to about 0 mol % and less than or equal to about 9 mol % Ta2O5;
greater than or equal to about 0 mol % and less than or equal to about 10 mol % La2O3; and
greater than or equal to about 0.05 mol % and less than or equal to about 1 mol % SnO2, wherein, Y2O3+Ta2O5+La2O3 is greater than or equal to about 2 mol % and less than or equal to about 15 mol %.

2. The glass composition of claim 1, wherein Y2O3+Ta2O5+La2O3 is greater than or equal to about 2 mol % and less than or equal to about 12 mol %.

3. The glass composition of claim 1, wherein the glass composition comprises greater than or equal to about 3 mol % and less than or equal to about 8 mol % Al2O3.

4. The glass composition of claim 1, wherein the glass composition comprises greater than or equal to about 6 mol % and less than or equal to about 14 mol % Li2O.

5. The glass composition of claim 1, wherein the glass composition comprises greater than or equal to about 0.5 mol % and less than or equal to about 9.5 mol % Y2O3.

6. The glass composition of claim 1, wherein the glass composition comprises greater than or equal to about 0.5 mol % and less than or equal to about 9 mol % Ta2O5.

7. The glass composition of claim 1, wherein the glass composition comprises greater than or equal to about 0.5 mol % and less than or equal to about 9.5 mol % La2O3.

8. The glass composition of claim 1, wherein the glass composition comprises greater than about 0 mol % and less than or equal to about 9 mol % ZrO2.

9. The glass composition of claim 1, wherein Al2O3+ZrO2 is greater than or equal to about 2 mol % and less than or equal to about 12 mol %.

10. A glass article comprising:
greater than or equal to about 70 mol % and less than or equal to about 90 mol % SiO2;
greater than or equal to about 2 mol % and less than or equal to about 9 mol % Al2O3;
greater than or equal to about 5 mol % and less than or equal to about 15 mol % Li2O;
greater than or equal to about 0 mol % and less than or equal to about 10 mol % Y2O3;
greater than or equal to about 0 mol % and less than or equal to about 9 mol % Ta2O5;
greater than or equal to about 0 mol % and less than or equal to about 10 mol % La2O3; and
greater than or equal to about 0.05 mol % and less than or equal to about 1 mol % SnO2, wherein, Y2O3+Ta2O5+La2O3 is greater than or equal to about 2 mol % and less than or equal to about 15 mol %.

11. The glass article of claim 10, wherein Y2O3+Ta2O5+La2O3 is greater than or equal to about 2 mol % and less than or equal to about 12 mol %.

12. The glass article of claim 10, wherein the glass article comprises greater than or equal to about 3 mol % and less than or equal to about 8 mol % Al2O3.

13. The glass article of claim 10, wherein the glass article comprises greater than or equal to about 6 mol % and less than or equal to about 14 mol % Li2O.

14. The glass article of claim 10, wherein the glass article comprises a Young's modulus greater than or equal to 60 GPa.

15. The glass article of claim 10, wherein the glass article comprises a fracture toughness greater than or equal to 0.7 MPa·m½.

16. The glass article of claim 10, wherein the glass article is an ion exchanged glass article.

17. The glass article of claim 16, wherein the ion exchanged glass article comprises a maximum central tension greater than or equal to 75 MPa, as measured at an article thickness of 0.6 mm.

18. The glass article of claim 16, wherein the ion exchanged glass article comprises a stored strain energy of greater than or equal to 10 J/m2 and the glass article is non-frangible.

19. A method of forming a glass article, the method comprising:
heating a glass composition, the glass composition comprising:
greater than or equal to about 70 mol % and less than or equal to about 90 mol % SiO2;
greater than or equal to about 2 mol % and less than or equal to about 9 mol % Al2O3;
greater than or equal to about 5 mol % and less than or equal to about 15 mol % Li2O;
greater than or equal to about 0 mol % and less than or equal to about 10 mol % Y2O3;
greater than or equal to about 0 mol % and less than or equal to about 9 mol % Ta2O5;
greater than or equal to about 0 mol % and less than or equal to about 10 mol % La2O3; and
greater than or equal to about 0.05 mol % and less than or equal to about 1 mol % SnO2, wherein, Y2O3+Ta2O5+La2O3 is greater than or equal to about 2 mol % and less than or equal to about 15 mol %; and
cooling the glass composition to form the glass article.

20. The method of claim 19, further comprising strengthening the glass article in an ion exchange bath at a temperature greater than or equal to 450° C. to less than or equal to 500° C. for a time period greater than or equal to 1 hour to less than or equal to 24 hours to form an ion exchanged glass article.
